(19) United States
(12) Patent Application Publication
(10) Pub. No.: US 2026/0230937 A1
(43) Pub. Date: Aug. 6, 2026

(54) METHOD AND APPARATUS FOR COMMUNICATING IN AN IAB NETWORK

(71) Applicant: Lenovo (Beijing) Limited, Beijing (CN)

(72) Inventors: Yibin Zhuo, Shanghai (CN); Haiyan Luo, Shanghai (CN); Mingzen Dai, Shanghai (CN); Lianhai Wu, Shanghai (CN); Le Yan, Shanghai (CN)

(73) Assignee: Lenovo (Beijing) Limited, Beijing (CN)

(21) Appl. No.: 19/152,301

(22) PCT Filed: Apr. 6, 2023
(86) PCT No.: PCT/CN2023/086527

§ 371 Date: Jul. 30, 2025

(51) Int. Cl. H04W 36/00; H04W 76/20; H04W 92/20

(52) U.S. Cl. CPC H04W 36/0016; H04W 76/20; H04W 92/20

(57) ABSTRACT

Embodiments of the present disclosure relate to a method and apparatus for communicating in an integrated access and backhaul (IAB) network. According to some embodiments of the disclosure, a first base station (BS) may: receive a transport migration management (TMM) request message from a second BS, wherein the TMM request message may include an identifier associated with a wireless network node for the first BS to identify the wireless network node; and transmit a TMM response message to the second 2024/087520 BS in response to receiving the TMM request message, wherein a mobile termination (MT) of the wireless network node hands over from a third BS to the first BS and a distributed unit (DU) of the wireless network node has an F1 connection to the second BS, or wherein the DU of the wireless network node migrates from a fourth BS to the second BS and the MT of the wireless network node has a radio resource control (RRC) connection to the first BS.

### TECHNICAL FIELD

Embodiments of the present disclosure generally relate to communication technology, and more particularly to communicating in an integrated access and backhaul (IAB) network.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), the 3rd generation partnership project (3GPP) is envisioning integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for facilitating communications in an IAB network.

### SUMMARY

Some embodiments of the present disclosure provide a first base station (BS). The first BS may include a processor; and a transceiver coupled to the processor. The transceiver may be configured to: receive a transport migration management (TMM) request message from a second BS, wherein the TMM request message may include an identifier associated with a wireless network node for the first BS to identify the wireless network node; and transmit a TMM response message to the second BS in response to receiving the TMM request message, wherein a mobile termination (MT) of the wireless network node hands over from a third BS to the first BS and a distributed unit (DU) of the wireless network node has an F1 connection to the second BS, or wherein the DU of the wireless network node migrates from a fourth BS to the second BS and the MT of the wireless network node has a radio resource control (RRC) connection to the first BS.

In some embodiments of the present disclosure, the identifier associated with the wireless network node may include one of the following: a cell radio network temporary identifier (C-RNTI) for the MT of the wireless network node, a BS-DU identifier (ID) of the DU of the wireless network node, a backhaul adaptation protocol (BAP) address of the wireless network node, a user equipment (UE) Xn application protocol (XnAP) ID for the MT of the wireless network node, and a BS-DU UE F1 application protocol (F1AP) ID of the DU of the wireless network node.

In some embodiments of the present disclosure, the TMM request message may include an information element (IE) indicating the identifier associated with the wireless network node and the IE is different from a non-F1-terminating BS UE XnAP ID IE in the TMM request message. In some embodiments of the present disclosure, the processor may be configured to ignore the non-F1-terminating BS UE XnAP ID IE in the TMM request message.

In some embodiments of the present disclosure, the processor may be further configured to allocate a UE XnAP ID for the MT of the wireless network node to be used over an Xn interface between the first BS and the second BS in response to receiving the TMM request message, and the TMM response message may include the allocated UE XnAP ID.

In some embodiments of the present disclosure, the identifier associated with the wireless network node may include a UE XnAP ID for the MT of the wireless network node to be used over an Xn interface between the first BS and the second BS.

In some embodiments of the present disclosure, the identifier associated with the wireless network node is included in a non-F1-terminating BS UE XnAP ID IE in the TMM request message.

In some embodiments of the present disclosure, the processor may be configured to allocate the UE XnAP ID for the MT of the wireless network node to be used over the Xn interface between the first BS and the second BS, and wherein the transceiver is further configured to transmit the allocated UE XnAP ID to the third BS or the wireless network node.

In some embodiments of the present disclosure, the transceiver may be further configured to receive a request message for the UE XnAP ID from the third BS or the wireless network node, and wherein allocating the UE XnAP ID may include allocating the UE XnAP ID in response to receiving the request message.

In some embodiments of the present disclosure, the request message is a handover request message from the third BS and the allocated UE XnAP ID is transmitted in a handover request acknowledgement message.

In some embodiments of the present disclosure, the request message from the third BS may include an identifier of the second BS and the identifier associated with the wireless network node; or wherein the request message from the wireless network node may include the identifier of the second BS.

In some embodiments of the present disclosure, during the migration of the DU of the wireless network node from the fourth BS to the second BS, the wireless network node may include a first DU having an F1 connection to the fourth BS and a second DU having an F1 connection to the second BS. The BS-DU ID of the DU of the wireless network node is a BS-DU ID of the first DU of the wireless network node and the BS-DU UE F1AP ID of the DU of the wireless network node is a BS-DU UE F1AP ID of the first DU of the wireless network node.

Some embodiments of the present disclosure provide a second BS. The second BS may include a processor; and a transceiver coupled to the processor. The transceiver may be configured to: transmit a TMM request message to a first BS, wherein the TMM request message may include an identifier associated with a wireless network node for the first BS to identify the wireless network node; and receive a TMM response message from the first BS in response to transmitting the TMM request message, wherein an MT of the wireless network node hands over from a third BS to the first BS and a DU of the wireless network node has an F1 connection to the second BS, or wherein the DU of the wireless network node migrates from a fourth BS to the second BS and the MT of the wireless network node has an RRC connection to the first BS.

In some embodiments of the present disclosure, the transceiver may be further configured to receive the identifier associated with the wireless network node from the third BS. The identifier associated with the wireless network node may include one of the following: a C-RNTI for the MT of the wireless network node, a BS-DU ID of the DU of the wireless network node, a BAP address of the wireless network node, and a UE XnAP ID for the MT of the wireless network node.

In some embodiments of the present disclosure, the transceiver may be further configured to receive the identifier associated with the wireless network node from the wireless network node. The identifier associated with the wireless network node may include one of the following: a C-RNTI for the MT of the wireless network node, a BS-DU ID of the DU of the wireless network node, a BAP address of the wireless network node, a UE XnAP ID for the MT of the wireless network node, and a BS-DU UE F1AP ID of the DU of the wireless network node.

In some embodiments of the present disclosure, the TMM request message may include an IE indicating the identifier associated with the wireless network node and the IE is different from a non-F1-terminating BS UE XnAP ID IE in the TMM request message.

In some embodiments of the present disclosure, the processor may be configured to set the non-F1-terminating BS UE XnAP ID IE in the TMM request message to be invalid or void.

In some embodiments of the present disclosure, the TMM response message may include a UE XnAP ID allocated by the first BS for the MT of the wireless network node to be used over an Xn interface between the first BS and the second BS.

In some embodiments of the present disclosure, the processor may be further configured to store the UE XnAP ID allocated by the first BS.

In some embodiments of the present disclosure, the identifier associated with the wireless network node may include a UE XnAP ID allocated by the first BS for the MT of the wireless network node to be used over an Xn interface between the first BS and the second BS.

In some embodiments of the present disclosure, the identifier associated with the wireless network node is included in a non-F1-terminating BS UE XnAP ID IE in the TMM request message.

In some embodiments of the present disclosure, the identifier associated with the wireless network node is received in an F1 setup request message.

In some embodiments of the present disclosure, during the migration of the DU of the wireless network node from the fourth BS to the second BS, the wireless network node may include a first DU having an F1 connection to the fourth BS and a second DU having an F1 connection to the second BS. The BS-DU ID of the DU of the wireless network node is a BS-DU ID of the first DU of the wireless network node and the BS-DU UE F1AP ID of the DU of the wireless network node is a BS-DU UE F1AP ID of the first DU of the wireless network node.

Some embodiments of the present disclosure provide a method performed by a first BS. The method may include: receiving a TMM request message from a second BS, wherein the TMM request message may include an identifier associated with a wireless network node for the first BS to identify the wireless network node; and transmitting a TMM response message to the second BS in response to receiving the TMM request message, wherein an MT of the wireless network node hands over from a third BS to the first BS and a DU of the wireless network node has an F1 connection to the second BS, or wherein the DU of the wireless network node migrates from a fourth BS to the second BS and the MT of the wireless network node has an RRC connection to the first BS.

Some embodiments of the present disclosure provide a method performed by a second BS. The method may include: transmitting a TMM request message to a first BS, wherein the TMM request message may include an identifier associated with a wireless network node for the first BS to identify the wireless network node; and receiving a TMM response message from the first BS in response to transmitting the TMM request message, wherein an MT of the wireless network node hands over from a third BS to the first BS and a DU of the wireless network node has an F1 connection to the second BS, or wherein the DU of the wireless network node migrates from a fourth BS to the second BS and the MT of the wireless network node has an RRC connection to the first BS.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2A and 2B illustrate example block diagrams of a protocol stack for an IAB network in accordance with some embodiments of the present disclosure;

FIGS. 3 and 4 illustrate exemplary handover cases in accordance with some embodiments of the present disclosure;

FIG. 5 illustrate an exemplary migration case in accordance with some embodiments of the present disclosure;

FIG. 6 illustrates a flow chart of an exemplary transport migration management (TMM) procedure in accordance with some embodiments of the present disclosure;

FIGS. 7 and 8 illustrate flow charts of exemplary handover procedures in accordance with some embodiments of the present disclosure;

FIGS. 9 and 10 illustrate flow charts of exemplary migration procedures in accordance with some embodiments of the present disclosure;

FIGS. 11 and 12 illustrate flow charts of exemplary procedures of wireless communications in accordance with some embodiments of the present disclosure; and

FIG. 13 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Compared with the 4G communication system, the 5G communication system has raised more stringent requirements for various network performance indicators, for example, a 1000-time capacity increase, wider coverage requirements, ultra-high reliability, ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. In addition, the deployment of optical fiber may be difficult and costly for these small stations. Therefore, an economical and convenient backhaul scheme is needed. Integrated access and backhaul (IAB) technology, whose access link(s) and backhaul link(s) may both use wireless transmission solutions to avoid fiber deployment, provides ideas for solving the above problems.

In an IAB network, a wireless network node such as a relay node (RN) or an IAB node or a wireless backhaul node/device can provide wireless access services for UEs. For example, a UE can connect to an IAB donor relayed by one or more IAB nodes. The IAB donor may also be called a donor node or a donor base station (e.g., DgNB, Donor gNodeB). In addition, the wireless link between an IAB donor and an IAB node, or the wireless link between different IAB nodes can be referred to as a “backhaul link.” The wireless network node in an IAB network may be stationary or mobile. Embodiments of the present disclosure can be applied to the wireless network node regardless of whether it is stationary or mobile.

An IAB node may include an IAB mobile terminal (MT) part and an IAB distributed unit (DU) part. When an IAB node connects to its parent node (which may be another IAB node or an IAB donor), it can be regarded as a UE, i.e., the role of an MT. When an IAB node provides service to its child node (which may be another IAB node or a UE), it can be regarded as a network device, i.e., the role of a DU.

An IAB donor can be an access network element with a complete base station function, or an access network element with a separate form of a centralized unit (CU) and a distributed unit (DU). The IAB donor may be connected to the core network (for example, connected to the 5G core (5GC) network), and provide the wireless backhaul function for the IAB nodes. The CU of an IAB donor may be referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the limited coverage of a high frequency band, and in order to ensure coverage performance of the network, multi-hop networking may be adopted in an IAB network. Taking into account the requirements of service transmission reliability, IAB nodes can support dual connectivity (DC) or multi-connectivity to improve transmission reliability, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and an IAB donor-CU). Each IAB node may treat the neighboring node that provides backhaul services for it as a parent node (or parent IAB node), and each IAB node can be regarded as a child node (or child IAB node) of its parent node.

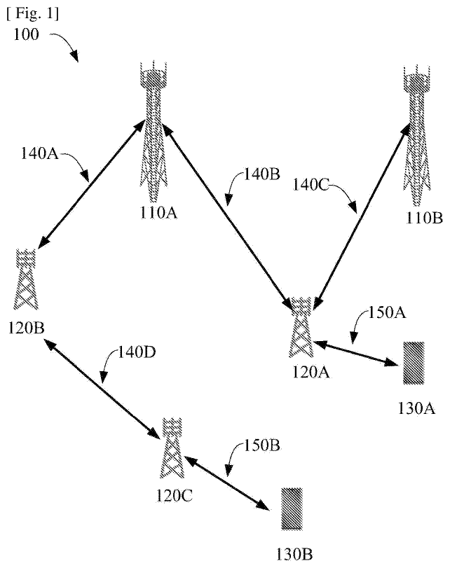

FIG. 1 illustrates a schematic diagram of wireless communication system 100 in accordance with some embodiments of the present disclosure.

As shown in FIG. 1, the wireless communication system 100 may include some base stations (e.g., IAB donor 110A and IAB donor 110B), some IAB nodes (e.g., IAB node 120A, IAB node 120B, and IAB node 120C), and some UEs (e.g., UE 130A and UE 130B). Although a specific number of UEs, IAB nodes, and IAB donors is depicted in FIG. 1, it is contemplated that any number of UEs, IAB nodes, and IAB donors may be included in the wireless communication system 100.

Each of IAB donor 110A, IAB donor 110B, IAB node 120A, IAB node 120B, and IAB node 120C may be directly connected to one or more IAB nodes in accordance with some other embodiments of the present disclosure. Each of IAB donor 110A, IAB donor 110B, IAB node 120A, IAB node 120B, and IAB node 120C may be directly connected to one or more UEs in accordance with some other embodiments of the present disclosure.

UE 130A and UE 130B may be any type of device configured to operate and/or communicate in a wireless environment. For example, UE 130A and UE 130B may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, UE 130A and UE 130B may include a portable wireless communication device, a smart phone, a cellular telephone, a flip phone, a device having a subscriber identity module, a personal computer, a selective call receiver, or any other device that is capable of transmission and receiving communication signals on a wireless network. In some embodiments of the present disclosure, UE 130A and UE 130B may include wearable devices, such as smart watches, fitness bands, optical head-mounted displays, internet-of-things (IOT) devices, or the like. Moreover, UE 130A and UE 130B may be referred to as a subscriber unit, a mobile, a mobile station, a user, a terminal, a mobile terminal, a wireless terminal, a fixed terminal, a subscriber station, a user terminal, or a device, or described using other terminology used in the art.

IAB donors 110A and 110B may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as gateways for the UEs to access a public switched telephone network (PSTN) and/or other networks (not shown in FIG. 1).

Wireless communication system 100 may be compatible with any type of network that is capable of transmitting and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, IAB donors 110A and 110B may transmit data using an orthogonal frequency division multiple (OFDM) modulation scheme on the DL. UE 130A and UE 130B may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Persons skilled in the art should understand that as technology develops and advances, the terminologies described in the present disclosure may change, but should not affect or limit the principles and spirit of the present disclosure.

Referring to FIG. 1, IAB node 120A can be directly connected to IAB donors 110A and 110B, and IAB node 120B can be directly connected to IAB donor 110A. IAB donors 110A and 110B are parent nodes of IAB node 120A, and IAB donor 110A is a parent node of IAB node 120B. In other words, IAB nodes 120A and 120B are child IAB nodes of IAB donor 110A, and IAB node 120A is also a child IAB node of IAB donor 110B. IAB node 120C can reach IAB donor 110A by hopping through IAB node 120B. IAB node 120B is a parent IAB node of IAB node 120C. In other words, IAB node 120C is a child IAB node of IAB node 120B.

In some other embodiments of the present disclosure, an IAB node may be connected to IAB node 120C so it can reach IAB donor 110A by hopping through IAB node 120C and IAB node 120B. This IAB node and IAB node 120C may be referred to as the descendant IAB nodes of IAB node 120B.

UEs 130A and 130B can be connected to IAB nodes 120A and 120C, respectively. IAB nodes 120A and 120C may therefore be referred to as access IAB nodes. Uplink (UL) packets (e.g., data or signaling) from UE 130A or UE 130B can be transmitted to an IAB donor (e.g., IAB donor 110A or 110B) via one or more IAB nodes, and then transmitted by the IAB donor to a mobile gateway device (such as the user plane function (UPF) in the 5GC). Downlink (DL) packets (e.g., data or signaling) can be transmitted from the IAB donor (e.g., IAB donor 110A or 110B) after being received by the gateway device, and then transmitted to UE 130A or 130B through one or more IAB nodes.

For example, referring to FIG. 1, UE 130A may transmit UL data to IAB donor 110A or 110B or receive DL data therefrom via IAB node 120A. UE 130B may transmit UL data to IAB donor 110A or receive DL data therefrom via IAB node 120C and IAB node 120B.

In an IAB deployment such as the wireless communication system 100, the radio link between an IAB donor (e.g., IAB donor 110A or 110B in FIG. 1) and an IAB node or between two IAB nodes may be referred to as a backhaul link (BL). The radio link between an IAB donor (e.g., IAB donor 110A or 110B in FIG. 1) and a UE or between an IAB node and a UE may be referred to as an access link (AL). For example, in FIG. 1, radio links 140A to 140D are BLs and radio links 150A and 150B are ALs.

A protocol layer, the backhaul adaptation protocol (BAP) layer, located above the radio link control (RLC) layer, is introduced in an IAB system and can be used to realize packet routing, bearer mapping and flow control on the wireless backhaul link.

An F1 interface may be established between an IAB node (e.g., DU part of the IAB node) and an IAB donor (e.g., IAB donor-CU). The F1 interface may support both a user plane protocol (e.g., F1-U) and a control plane protocol (e.g., F1-C). The user plane protocol of the F1 interface may include one or more of a general packet radio service (GPRS) tunneling protocol user plane (GTP-U), user datagram protocol (UDP), internet protocol (IP) and other protocols. The control plane protocol of the F1 interface may include one or more of an F1 application protocol (F1AP), stream control transport protocol (SCTP), IP, and other protocols.

Through the control plane of the F1 interface, an IAB node and an IAB donor can perform, for example, interface management, IAB-DU management, and a UE context-related configuration. Through the user plane of the F1 interface, an IAB node and an IAB donor can perform, for example, user plane data transmission and downlink transmission status feedback functions.

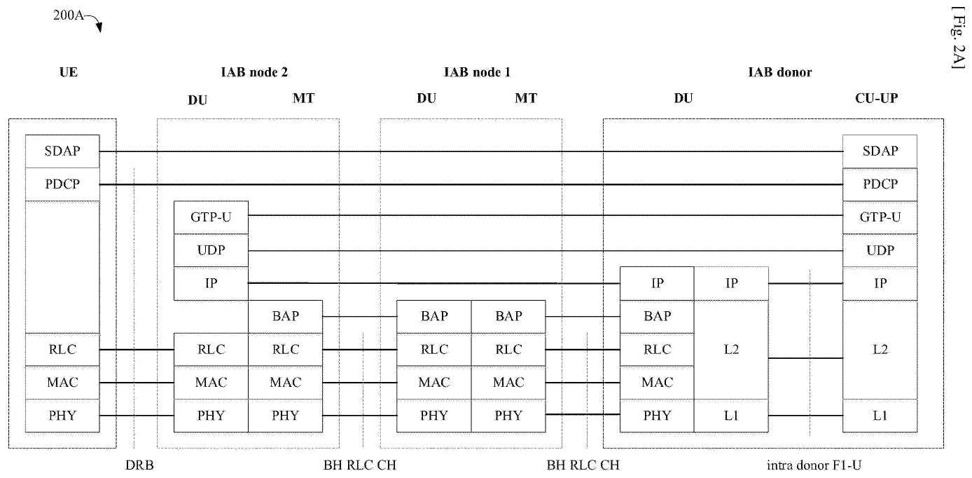

FIG. 2A illustrates an example block diagram of user plane (UP) protocol stack 200A for an IAB network according to some embodiments of the present disclosure. FIG. 2B illustrates an example block diagram of control plane (CP) protocol stack 200B for an IAB network according to some embodiments of the present disclosure. In FIGS. 2A and 2B, a UE may be connected to an IAB donor via IAB node 2 and IAB node 1. In some other embodiments of the present disclosure, a UE may be connected to an IAB donor via more or less IAB nodes.

Referring to FIG. 2A, the UP protocol stack of the UE may include a service data adaptation protocol (SDAP) layer, a packet data convergence protocol (PDCP) layer, a radio link control (RLC) layer, a medium access control (MAC) layer, and a physical (PHY) layer. The UP protocol stack of the DU of IAB node 2 may include a GTP-U layer, a UDP layer, an IP layer, an RLC layer, a MAC layer, and a PHY layer. The UP protocol stack of the MT of IAB node 2 or the DU or MT of IAB node 1 may include a BAP layer, an RLC layer, a MAC layer, and a PHY layer. The UP protocol stack of the DU of the IAB donor may include an IP layer, a BAP layer, an RLC layer, a MAC layer, and a PHY layer, where the PHY layer belongs to layer 1 (L1), and the BAP layer, the RLC layer, and the MAC layer belong to layer 2 (L2). The protocol stack of the CU-UP of the IAB donor may include a GTP-U layer, a UDP layer, an IP layer, an SDAP layer, a PDCP layer, an L2 layer(s), and an L1 layer.

Referring to FIG. 2B, the CP protocol stack of the UE may include a radio resource control (RRC) layer, a PDCP layer, an RLC layer, a MAC layer, and a physical (PHY) layer. The CP protocol stack of the DU of IAB node 2 may include an F1AP layer, an SCTP layer, an IP layer, an RLC layer, a MAC layer, and a PHY layer. The CP protocol stack of the MT of IAB node 2 or the DU or MT of IAB node 1 may include a BAP layer, an RLC layer, a MAC layer, and a PHY layer. The CP protocol stack of the DU of the IAB donor may include an IP layer, a BAP layer, an RLC layer, a MAC layer, and a PHY layer, where the PHY layer belongs to L1, and the BAP layer, the RLC layer, and the MAC layer belong to L2. The protocol stack of the CU-CP of the IAB donor may include an RRC layer, a PDCP layer, an F1AP layer, an SCTP layer, an IP layer, an L2 layer(s), and an L1 layer.

The protocol stacks shown in FIGS. 2A and 2B are only for illustrative purposes.

For example, the sequences of some of the protocol layers in the protocol stacks of FIGS. 2A and 2B may be rearranged for illustrative purposes. For example, although the SDAP and PDCP layers belong to L2, they are shown above the GTP-U layer, the UDP layer and the IP layer in the protocol stack of the CU-UP of the IAB donor in FIG. 2A.

The signals between each node in an IAB network may include, for example, the following and can be applied to the present disclosure:
an IAB donor-CU and an IAB donor-DU: an F1AP message;
an IAB donor-CU and an IAB node: an F1AP message between the CU and the IAB-DU or an RRC message between the CU and the IAB-MT;
an IAB donor-CU and a UE: an RRC message;
an access IAB node and a UE: L2-control PDU, such as a MAC control element (CE) or a RLC control PDU; and
an IAB node and another child or parent IAB node: L2-control PDU, such as a MAC CE, a RLC control PDU, or a BAP control PDU.

As demand for improved cellular coverage and connectivity continues to increase, communications in outdoor and mobility scenarios may face more challenges. In some embodiments of the present disclosure, a mobile wireless network node which acts as a relay between a UE and the 3GPP communication network (e.g., 5G) may be employed to facilitate communications in such scenarios. The mobile wireless network node may provide, for example, an access link to UEs and connected wirelessly (e.g., using NR) through a BS (e.g., donor next-generation radio access network (NG-RAN) to the core network. In some examples, such mobile wireless network node may also be referred to as a mobile base station relay or mobile relay. The above descriptions with respect to the wireless network node and the IAB node can be applied to the mobile base station relay. That is, a mobile base station relay can be a mobile IAB node.

In some examples, the mobile base station relay may be mounted on a vehicle. The mobile base station relay may serve UEs that are located inside (onboard) or outside (surrounding) the vehicle, or UEs that enter or leave the vehicle. In the context of the present disclosure, inside or outside of a mobile base station relay may mean inside or outside of a vehicle or other device(s) on which the mobile wireless network node is mounted.

In some examples, the radio link used between a mobile base station relay and the served UEs, as well as between the mobile base station relay and the BS, may be a Uu link (e.g., NR-Uu), which is different from a UE relay (which uses a PC5G-based link to provide, for example, an indirect connection to remote UEs). In some examples, there may be at least one hop between a UE and a mobile base station relay. In some examples, there may be at least one hop between a mobile base station relay and a BS.

The employment of such mobile wireless network node is advantageous in various aspects and can be applied to various scenarios. For example, in some outdoor environments, the availability of vehicles equipped with mobile base station relays, either following a certain known/predictable itinerary (e.g., buses, trams, etc.), or situated in convenient locations (e.g., outside stadiums, hot-spot areas, or emergency sites), may provide a very opportunistic boost to cellular coverage and capacity when or where needed. Those relays may use, for example, a 5G wireless backhaul toward the macro network, and thus can offer better coverage and connectivity to neighboring UEs. Mobile relays are also very suitable for improving connectivity for users or devices inside a vehicle on which the mobile relay is mounted in different environments, for example, for passengers in buses, cars/taxis, or trains, ad-hoc/professional personnel or equipment. Such mobile wireless network node can also be used for reaching users or devices that would otherwise have no or very poor macro coverage, for example, in the case of first responders dislocated in indoor buildings/areas, using relays placed on their nearby or outside vehicles to get required coverage and connectivity.

The technical benefits of using such a mobile wireless network node(s) further include, among others, the ability to get better macro coverage than a nearby UE, for example, exploiting better radio frequency, antenna and power capabilities. In addition, besides the value for network operators and end users, worthy incentives may be found for other parties as well, for example, for vehicle manufacturers, and vehicle and fleet owners or providers, to install and operate relays in their vehicles.

In the context of the present disclosure, a wireless network node may refer to either a stationary or mobile wireless network node.

Due to the mobility of a wireless network node (e.g., an IAB node), the wireless network node may need to migrate (or hand over) from one IAB donor to another IAB donor (i.e., inter-donor migration).

In some embodiments, the MT of a wireless network node may migrate from an initial (source) IAB donor to a new (target) IAB donor. For example, the MT of a wireless network node may migrate to a different parent node underneath a different CU of an IAB donor. For instance, referring back to FIG. 1, the MT of IAB node 120C or IAB node 120B may migrate from IAB donor 110A to IAB donor 110B. In this scenario, the DU of the wireless network node and the DU of the descendant node(s) of the wireless network node may retain F1 connectivity with the source IAB donor (e.g., CU of the source IAB donor). This migration may be referred to as inter-donor partial migration or inter-donor IAB-MT handover. The wireless network node which performs the inter-donor partial migration may be referred to as a boundary wireless network node. After the inter-donor partial migration, the F1 traffic of the DU of the wireless network node and the DU of the descendant node(s) of the wireless network node may be routed via, for example, the BAP layer of the IAB topology to which the MT of the wireless network node has migrated.

In some embodiments, the DU of a wireless network node may migrate from an initial (source) IAB donor to a new (target) IAB donor. This migration may be referred to as inter-donor IAB-DU migration. In some embodiments, to execute the handover of the UEs served by the wireless network node (e.g., its DU), the wireless network node may concurrently support two logical DUs (e.g., DU #1 and DU #2), which may have F1AP associations with the source IAB donor (e.g., CU of the source IAB donor) and the target IAB donor (e.g., CU of the target IAB donor), respectively. The UEs connected to the wireless network node may be handed over from a cell of DU #1 (i.e., the source DU of the wireless network node) to a cell of DU #2 (i.e., the target DU of the wireless network node). After the migration of the DU of the wireless network node, the F1 interface between DU #1 and the source IAB donor can be released.

In the context of the present disclosure, the terms handover and migration may be used interchangeably. It should be noted that, although embodiments of the present disclosure may be discussed under a specific network architecture (e.g., the IAB architecture) and based on certain specific components (e.g., an IAB donor or an IAB node), embodiments of the present disclosure are also applicable to other similar network architectures and new service scenarios. It should be noted that although in the context of the present disclosure, both a BS (e.g., an IAB donor) and a network node (e.g., an IAB node) may include a DU, the DU of a BS and the DU of a network node generally function differently.

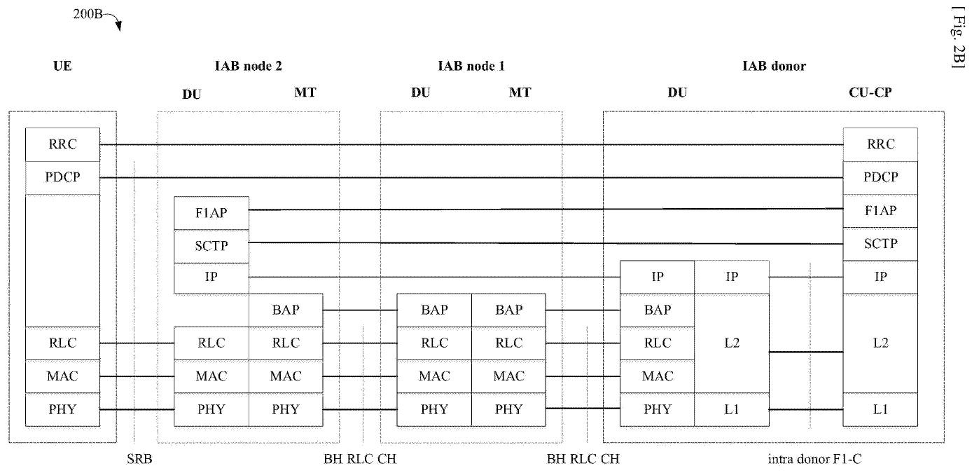

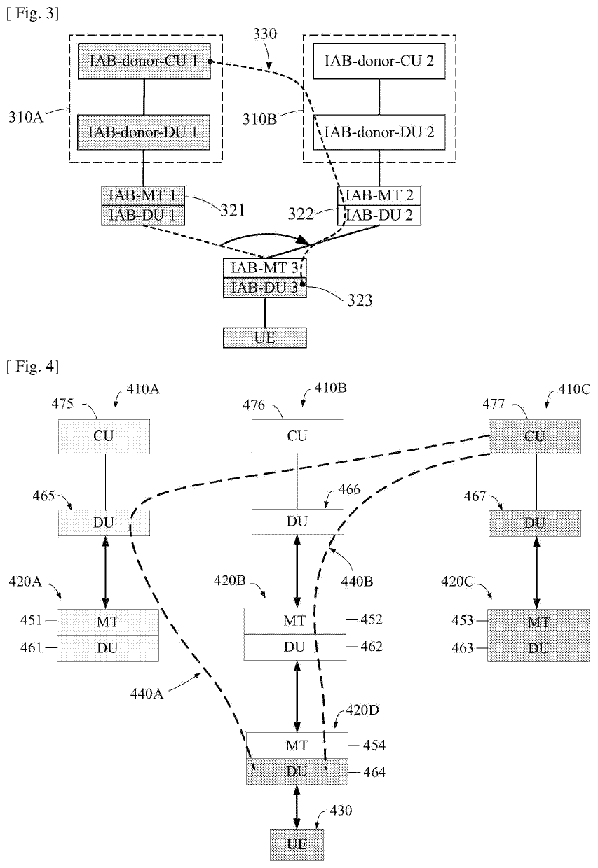

For example, FIG. 3 shows an exemplary handover case in accordance with some embodiments of the present disclosure. Referring to FIG. 3, IAB donor 310A may include IAB-donor-CU1 and IAB-donor-DU1, and IAB donor 310B may include IAB-donor-CU2 and IAB-donor-DU2. IAB node 321 may connect to IAB donor 310A and may include IAB-MT 1 and IAB-DU 1, and IAB node 322 may connect to IAB donor 310B and may include IAB-MT 2 and IAB-DU 2. IAB node 323 may include IAB-MT 3 and IAB-DU 3. Details described in all of the foregoing embodiments of the present disclosure are applicable to FIG. 3.

In the example of FIG. 3, the MT (IAB-MT 3) of IAB node 323 may hand over from IAB-donor-CU1 to IAB-donor-CU2. Before the handover of IAB node 323, IAB node 323 can reach IAB donor 310A via IAB node 321. Both IAB-MT 3 and IAB-DU 3 may be anchored at IAB-donor-CU1. During the handover of IAB-MT 3, the F1 transport between IAB-DU 3 and IAB donor 310A (e.g., IAB-donor-CU1) is switched from a source path (not shown in FIG. 3) under the topology of IAB donor 310A (e.g., IAB-donor-CU1) to a target path (denoted by signaling flow 330) under the topology of IAB donor 310B (e.g., IAB-donor-CU2).

After the handover of IAB node 323, IAB-MT 3 may be handed over from IAB donor 310A to IAB donor 310B and IAB-DU 3 may still be under the control of IAB-donor-CU1. That is, after the MT handover, IAB-MT 3 may be anchored at IAB-donor-CU2 and IAB-DU 3 may still be anchored at IAB-donor-CU1. IAB-donor-CU1 can be referred to as an “F1-terminating CU.” IAB-donor-CU2 can be referred to as a “non-F1-terminating CU” or “RRC terminating CU”. IAB donor 310A can be referred to as an “F1-terminating IAB donor” or “F1-terminating BS.” IAB donor 310B can be referred to as a “non-F1-terminating IAB donor,” “non-F1-terminating BS,” or “RRC terminating BS.”

FIG. 4 shows an exemplary handover case in accordance with some other embodiments of the present disclosure. In the example of FIG. 4, the MT of a wireless network node hands over from a BS to another BS while the DU of the wireless network node connects to yet another BS (hereinafter, “Scenario 1”). Details described in all of the foregoing embodiments of the present disclosure are applicable to FIG. 4.

Referring to FIG. 4, IAB donor 410A may include CU 475 and DU 465, IAB donor 410B may include CU 476 and DU 466, and IAB donor 410C may include CU 477 and DU 467. IAB node 420A may be directly connected to IAB donor 410A and may include MT 451 and DU 461. IAB node 420B may be directly connected to IAB donor 410B and may include MT 452 and DU 462. IAB node 420C may be directly connected to IAB donor 410C and may include MT 453 and DU 463. IAB node 420D may include MT 454 and DU 464, and UE 430 may be connected to IAB node 420D. IAB node 420D may be referred to as an access IAB node of UE 430.

DU 464 of IAB node 420D may be anchored at IAB donor 410C (e.g., CU 477). IAB donor 410C may be referred to as the F1-terminating BS of IAB node 420D. MT 454 of IAB node 420D may be handed over (or migrated) from IAB donor 410A (i.e., source non-F1-terminating BS) to IAB donor 410B (i.e., target non-F1-terminating BS). During the handover of MT 454, the F1 transport between DU 464 and IAB donor 410C is switched from the topology of IAB donor 410A (e.g., denoted by signaling flow 440A) to the topology of IAB donor 410B (e.g., denoted by signaling flow 440B).

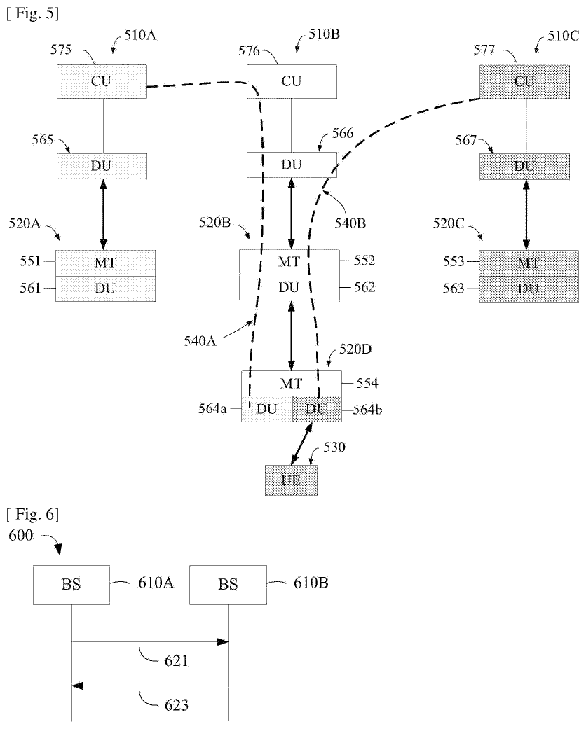

FIG. 5 shows an exemplary migration case in accordance with some embodiments of the present disclosure. In the example of FIG. 5, the DU of a wireless network node migrates from a BS to another BS while the MT of the wireless network node connects to yet another BS (hereinafter, “Scenario 2”). Details described in all of the foregoing embodiments of the present disclosure are applicable to FIG. 5.

Referring to FIG. 5, IAB donor 510A may include CU 575 and DU 565, IAB donor 510B may include CU 576 and DU 566, and IAB donor 510C may include CU 577 and DU 567. IAB node 520A may be directly connected to IAB donor 510A and may include MT 551 and DU 561. IAB node 520B may be directly connected to IAB donor 510B and may include MT 552 and DU 562. IAB node 520C may be directly connected to IAB donor 510C and may include MT 553 and DU 563. IAB node 520D may include MT 554 and two DUs (DU 564a and DU 564b), and UE 530 may be connected to IAB node 520D. IAB node 520D may be referred to as an access IAB node of UE 530.

MT 554 of IAB node 520D may be anchored at IAB donor 510B (e.g., CU 576). IAB donor 510B may be referred to as the non-F1-terminating BS of IAB node 520D. The DU of IAB node 520D may be migrated from IAB donor 510A (i.e., source F1-terminating BS) to IAB donor 510C (i.e., target F1-terminating BS). Before the DU migration, only DU564a of the IAB node 520D has an F1 connection to IAB donor 510A (e.g., denoted by signaling flow 540A). During the DU migration, IAB node 520D may have two DUs (e.g., DU 564a and DU 564b as shown in FIG. 5). DU 564a may have an F1 connection to IAB donor 510A and DU 564b may have an F1 connection to IAB donor 510C (e.g., denoted by signaling flow 540B). And after the DU migration, only DU564b of the IAB node 520D has an F1 connection to IAB donor 510C. Both F1 connections are transported via the topology of IAB donor 510B.

The MT handover and DU migration shown in FIGS. 3-5 are only for illustrative purpose. For example, in some other embodiments, the MT and DU of a wireless network node may be anchored at the same BS (e.g., IAB donor) and the DU of the wireless network node may migrate from the source BS to a target BS (e.g., IAB donor). For example, in some other embodiments, the wireless network node may hop through one or more wireless network nodes (e.g., IAB nodes) before reaching the source or target BS, or may be directly connected to the source or target BS.

Embodiments of the present disclosure provide solutions for facilitating the handover or migration of a wireless network node.

For example, in Scenario 1, the F1-terminating BS (e.g., IAB donor 410C in FIG. 4) may not be aware that the wireless network node has performed the IAB-MT handover to the (target) non-F1-terminating BS (e.g., IAB donor 410B in FIG. 4) via the handover or migration procedure; and in Scenario 2, the (target) F1-terminating BS (e.g., IAB donor 510C in FIG. 5) may not be aware of which node is the non-F1-terminating BS (e.g., IAB donor 510B in FIG. 5). Embodiments of the present disclosure provide solutions for informing the F1-terminating BS (or the F1-terminating CU) of the existence of the non-F1-terminating BS (or the non-F1-terminating CU), and solutions for associating the wireless network node between the F1-terminating BS (or the F1-terminating CU) and the non-F1-terminating BS (or the non-F1-terminating CU).

For example, as described above, the MT and DU of a wireless network node may be connected to different BSs (or CUs). In some embodiments of the present disclosure, in order to exchange information between the two BSs (or CUs) and to manage the migration of the wireless network node and descendant wireless network node traffic between the topologies managed by the two BSs (or CUs), a TMM procedure between the two BSs (or CUs) may be performed. In the context of an IAB network, a TMM procedure may also be referred to as an IAB TMM procedure.

For example, a TMM procedure may be performed between an F1-terminating BS (e.g., F1-terminating IAB-donor-CU) and a non-F1-terminating BS (e.g., non-F1-terminating IAB-donor-CU) of a wireless network node (e.g., an IAB node) to exchange information and manage the migration of the wireless network node and the descendant node traffic between the topologies managed by the two BSs (e.g., two IAB-donor-CUs). For example, the procedure may be initiated by the F1-terminating BS (e.g., F1-terminating IAB-donor-CU) of the IAB-node. For example, the procedure can be used to set up, modify and release (e.g., for the purpose of revoking) the resources under the non-F1-terminating BS (e.g., non-F1-terminating IAB-donor-CU) used for serving the offloaded traffic.

FIG. 6 illustrates a flow chart of exemplary TMM procedure 600 in accordance with some embodiments of the present disclosure. Details described in all of the foregoing embodiments of the present disclosure are applicable for the embodiments shown in FIG. 6. For example, BSs 610A and 610B may function as the IAB donors as described above and may include a CU and at least one DU.

BSs 610A and 610B may be the F1-terminating BS and non-F1-terminating BS of a wireless network node (denoted as node #1 for clarity). For example, the DU of node #1 may have an F1 connection to BS 610A and the MT of node #1 may have an RRC connection to BS 610B. In operation 621, BS 610A may transmit a TMM request message (e.g., an IAB TMM request message) to BS 610B. In operation 623, BS 610B may transmit a TMM response message (e.g., an IAB TMM response message) to BS 610A as a response.

In some embodiments of the present disclosure, the TMM request message and TMM response message may indicate UE XnAP IDs (e.g., NG-RAN node UE XnAP IDs) allocated by both the BS 610A and BS 610B for the MT of node #1 to be used over the Xn interface between BS 610A and BS 610B. The two UE XnAP IDs may be included in the F1-Terminating BS UE XnAP ID IE and Non-F1-Terminating BS UE XnAP ID IE respectively in the TMM request and TMM response messages.

The UE XnAP IDs may be allocated by BS 610A and BS 610B. For example, the MT of node #1 may be handed over from BS 610A to BS 610B. For example, node #1 may perform a handover procedure as shown in FIG. 3. For example, the MT of node #1 may be handed over from BS 610A to BS 610B while the DU of node #1 may still be under the control of BS 610A. During the handover of the MT of node #1 from BS 610A to BS 610B (e.g., during an IAB-MT handover preparation procedure), BS 610A (e.g., CU of BS 610A) may allocate a UE XnAP ID (denoted as “ID #1”) for the MT of node #1, which may be included in a handover request message from BS 610A to BS 610B. BS 610B (e.g., CU of BS 610B) may feedback a UE XnAP ID (denoted as “ID #2”) for the MT of node #1. For example, BS 610B may transmit a handover request acknowledgement message including ID #2 to BS 610A. The handover request acknowledgement message may also include ID #1. After the handover preparation procedure, BS 610A (e.g., CU of BS 610A) and BS 610B (e.g., CU of BS 610B) may have the UE XnAP IDs for the MT of node #1 allocated by each other. After the handover of the MT of node #1 from BS 610A to BS 610B, BS 610A (e.g., CU of BS 610A) may trigger a TMM procedure as shown in FIG. 6. The UE XnAP IDs (e.g., ID #1 and ID #2) allocated by BS 610A (e.g., CU of BS 610A) and BS 610B (e.g., CU of BS 610B) may be included in the TMM request message and TMM response message.

In Scenarios 1 and 2 (e.g., FIGS. 4 and 5), after the MT handover or DU migration, the F1 signaling between the F1-terminating BS and the wireless network node (e.g., the F1 signaling between IAB donor 410C and IAB node 420D in FIG. 4 or the F1 signaling between IAB donor 510C and IAB node 520D in FIG. 5) may be transported via the backhaul links under the topology of the non-F1-terminating BS (e.g., IAB donor 410B in FIG. 4 or IAB donor 510B in FIG. 5). Similarly, the F1-terminating BS (e.g., IAB donor 410C in FIG. 4 or IAB donor 510C in FIG. 5) may trigger a TMM procedure to the non-F1-terminating BS (e.g., IAB donor 410B in FIG. 4 or IAB donor 510B in FIG. 5) to exchange information and manage the migration of traffic between the two BSs (e.g., the two CUs). However, in Scenarios 1 and 2, the F1-terminating BS and non-F1-terminating BS may have not allocated and exchanged the UE XnAP IDs for the Xn interface between the F1-terminating BS and non-F1-terminating BS.

Embodiments of the present disclosure provide solutions for exchanging the UE XnAP IDs for the Xn interface between the F1-terminating BS and non-F1-terminating BS. For example, as such IDs are required for the TMM procedure between the F1-terminating BS and non-F1-terminating BS (e.g., the F1-terminating BS may trigger a TMM request including a non-F1-Terminating BS UE XnAP ID to the non-F1-terminating BS), embodiments of the present disclosure provide solutions for setting the non-F1-Terminating BS UE XnAP ID in the TMM request message.

More details on the embodiments of the present disclosure will be illustrated in the following text in combination with the appended drawings.

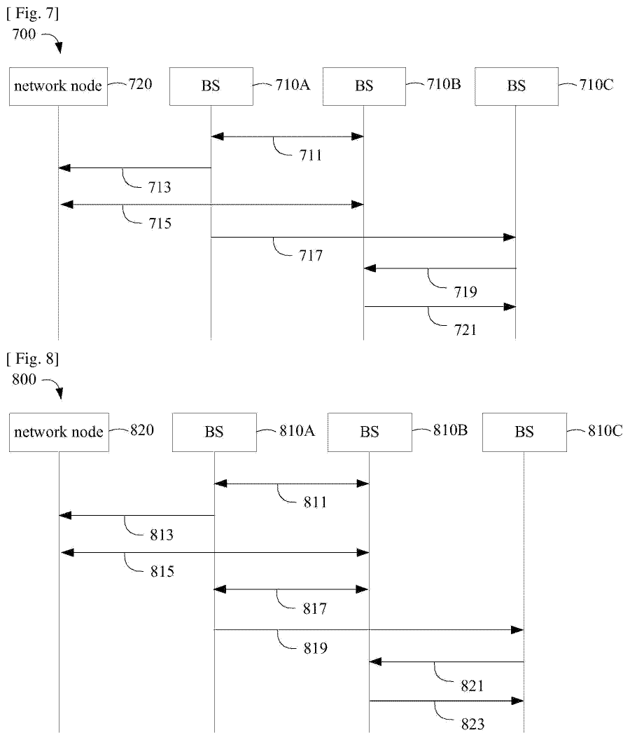

For example, FIG. 7 illustrates a flow chart of exemplary handover procedure 700 in accordance with some embodiments of the present disclosure.

Details described in all of the foregoing embodiments of the present disclosure are applicable for the embodiments shown in FIG. 7. For example, BSs 710A-710C may function as the IAB donors as described above and may include a CU and at least one DU. Network node 720 may function as the IAB nodes as described above, and may include an MT and a DU.

Network node 720 (e.g., DU of network node 720) may have an F1 connection with BS 710C (e.g., CU of BS 710C). Network node 720 (e.g., MT of network node 720) may have an RRC connection with BS 710A (e.g., CU of BS 710A). BS 710C and BS 710A may be referred to as an F1 terminating BS and a non-F1 terminating BS (or RRC terminating BS), respectively. The CU of BS 710C and the CU of BS 710A may be referred to as an F1 terminating BS-CU and a non-F1 terminating BS-CU (or RRC terminating BS-CU), respectively.

In some embodiments, the MT of network node 720 may perform a handover from BS 710A (i.e., source non-F1 terminating BS) to a target BS (i.e., target non-F1 terminating BS such as BS 710B) while the DU of network node 720 retains its connection with BS 710C (e.g., CU of BS 710C). For example, BS 710A, BS 710B, BS 710C and network node 720 may function as IAB donor 410A, IAB donor 410B, IAB donor 410C, and IAB node 420D in FIG. 4.

For example, referring to FIG. 7, in operation 711, a handover preparation procedure for network node 720 (e.g., MT of network node 720) may be performed between BS 710A and BS 710B. For example, BS 710A (e.g., CU of BS 710A) may transmit a handover request message to BS 710B (e.g., CU of BS 710B) to hand over network node 720 (e.g., MT of network node 720). BS 710B (e.g., CU of BS 710B) may transmit a response to the handover request message (e.g., positive feedback such as a handover request acknowledgement message or negative feedback such as a handover preparation failure message) to BS 710A.

In some embodiments, operation 711 may further include the following steps: BS 710B (e.g., CU of BS 710B) sets up the UE context for network node 720 (e.g., MT of network node 720) in the target parent node, performs admission control for network node 720 (e.g., MT of network node 720), and provides RRC reconfiguration (e.g., handover command) as a part of the handover request acknowledgement message.

In some embodiments, the handover request message may include a UE XnAP ID (e.g., an NG-RAN node UE XnAP ID, denoted as ID #7A) allocated by BS 710A (e.g., CU of BS 710A). The handover request acknowledgement message may include a UE XnAP ID (e.g., an NG-RAN node UE XnAP ID, denoted as ID #7B) allocated by BS 710B (e.g., CU of BS 710B). The handover request acknowledgement message may also include ID #7A. ID #7A and ID #7B can be used over the Xn interface between BS 710A (e.g., CU of BS 710A) and BS 710B (e.g., CU of BS 710B).

In operation 713, BS 710A (e.g., CU of BS 710A) may transmit a handover command (e.g., RRC reconfiguration) to network node 720 (e.g., MT of network node 720). In some embodiments, the handover command or RRC reconfiguration can be included in a UE context modification request message to the source parent node (e.g., DU of the source parent node of network node 720). In some examples, assuming that network node 720 functions as IAB node 420D in FIG. 4, the source and target parent nodes of network node 720 may be IAB node 420A and IAB node 420B, respectively. The source parent node (e.g., DU of the source parent node of network node 720) may forward the received handover command or RRC reconfiguration to the migrating node (e.g., MT of network node 720). In some examples, the source or target parent node of network node 720 may be a BS or an IAB donor.

In operation 715, network node 720 (e.g., MT of network node 720) may perform a random access procedure with the target parent node (e.g., DU of the target parent node of network node 720) and set up an RRC connection to BS 710B (e.g., CU of BS 710B).

In operation 717, BS 710A (e.g., CU of BS 710A) may transmit a message to BS 710C (e.g., CU of BS 710C) to indicate that network node 720 (e.g., MT of network node 720) has been handed over to BS 710B (e.g., CU of BS 710B).

In some embodiments, the message in operation 717 may include an identifier of BS 710B (e.g., ID of CU of BS 710B), such that BS 710C (e.g., CU of BS 710C) can trigger a TMM procedure to the correct non-F1-terminating BS (e.g., non-F1-terminating CU such as CU of BS 710B). For example, the ID of BS 710B can be a gNB ID of BS 710B, gNB-CU ID of the CU of BS 710B, an IP address of the CU of BS 710B, or any ID that can identify BS 710B (e.g., CU of BS 710B).

In some embodiments, the message in operation 717 may include an identifier (ID) associated with network node 720. As will be described later, the ID associated with network node 720 may be used for BS 710B (e.g., CU of BS 710B) to identify network node 720. That is, any ID associated with network node 720 that is known by BS 710B (e.g., CU of BS 710B) can be employed.

For example, the ID associated with network node 720 may be an ID of the MT of network node 720, an ID of the DU of network node 720, or an ID of network node 720. For example, the ID associated with network node 720 may be a cell radio network temporary identifier (C-RNTI) for the MT of network node 720, a BS-DU ID (e.g., gNB-DU ID) of the DU of network node 720, a BAP address of network node 720, or a UE XnAP ID (e.g., an NG-RAN node UE XnAP ID) for the MT of network node 720. For example, the ID associated with network node 720 may be the UE XnAP ID for the MT of network node 720 allocated by BS 710B (e.g., ID #7B) or BS 710A (e.g., ID #7A).

BS 710C (e.g., CU of BS 710C) may then trigger a TMM procedure (e.g., IAB TMM procedure) to exchange information between BS 710C (e.g., CU of BS 710C) and BS 710B (e.g., CU of BS 710B) of network node 720 and to manage the migration of network node 720 and descendant node traffic between the topologies managed by the two BSs (e.g., the two CUs). For example, in operation 719, BS 710C (e.g., CU of BS 710C) may transmit a TMM request message to BS 710B (e.g., CU of BS 710B).

In some embodiments, the TMM request message may include the ID associated with network node 720 as described above with respect to operation 717.

In some embodiments, the TMM request message may include a non-F1-terminating BS UE XnAP ID IE (e.g., non-F1-terminating IAB-donor UE XnAP ID IE). As described above with respect to FIG. 6, the F1-terminating BS (e.g., BS 710C) is supposed to include a UE XnAP ID (e.g., NG-RAN node UE XnAP ID) for the MT of a wireless network node (e.g., network node 720), which is allocated by the non-F1-terminating BS (e.g., BS 710B) and to be used over the Xn interface between the F1-terminating BS (e.g., BS 710C) and non-F1-terminating BS (e.g., BS 710B), in the non-F1-terminating BS UE XnAP ID IE. For example, the value of the IE is the ID or the IE is set as the ID. However, in the example of FIG. 7, BS 710C (e.g., CU of BS 710C) has no information for such UE XnAP ID at operation 717. BS 710C (e.g., CU of BS 710C) may set the non-F1-terminating BS UE XnAP ID IE in the TMM request message to be invalid or void. For example, BS 710C (e.g., CU of BS 710C) may use an invalid or void ID to set the non-F1-terminating BS UE XnAP ID IE.

In some embodiments, the ID associated with network node 720 may be included in an IE of the TMM request message which is different from the non-F1-terminating BS UE XnAP ID IE.

In some embodiments, the TMM request message may include an F1-terminating BS UE XnAP ID IE (e.g., F1-terminating IAB-donor UE XnAP ID IE), which may include a UE XnAP ID (e.g., NG-RAN node UE XnAP ID) allocated by BS 710C (e.g., CU of BS 710C) and to be used over the Xn interface between BS 710C and BS 710B. For example, the value of the F1-terminating BS UE XnAP ID IE may be the UE XnAP ID allocated by BS 710C or the F1-terminating BS UE XnAP ID IE may be set as the UE XnAP ID allocated by BS 710C.

In some embodiments, based on the ID associated with network node 720 in the TMM request message, BS 710B (e.g., CU of BS 710B) can recognize network node 720. In some embodiments, BS 710B (e.g., CU of BS 710B) may ignore the non-F1-terminating BS UE XnAP ID IE in the TMM request message. For example, when the TMM request message includes the ID associated with network node 720, BS 710B (e.g., CU of BS 710B) may ignore the non-F1-terminating BS UE XnAP ID IE.

In some embodiments, BS 710B (e.g., CU of BS 710B) may allocate a UE XnAP ID (e.g., NG-RAN node UE XnAP ID) for the MT of network node 720 to be used over the Xn interface between BS 710B and BS 710C in response to receiving the TMM request message. For example, when the TMM request message includes the ID associated with network node 720, BS 710B (e.g., CU of BS 710B) may allocate the UE XnAP ID for the MT of network node 720.

In operation 721, BS 710B (e.g., CU of BS 710B) may transmit a TMM response message to BS 710C (e.g., CU of BS 710C) as a response to the TMM request message. In some embodiments, the TMM response message may include the UE XnAP ID allocated by BS 710B (e.g., CU of BS 710B) to be used over the Xn interface between the F1-terminating BS (e.g., BS 710C) and non-F1-terminating BS (e.g., BS 710B). For example, BS 710B (e.g., CU of BS 710B) may set a non-F1-terminating BS UE XnAP ID IE (e.g., non-F1-terminating IAB-donor UE XnAP ID IE) in the TMM response message to be the allocated UE XnAP ID. For example, the value of the non-F1-terminating BS UE XnAP ID IE in the TMM response message is the allocated UE XnAP ID.

In some embodiments, the TMM response message may also include an F1-terminating BS UE XnAP ID IE (e.g., F1-terminating IAB-donor UE XnAP ID IE), which is set as the same value as the F1-terminating BS UE XnAP ID IE in the TMM request message.

In some embodiments, BS 710C (e.g., CU of BS 710C) may store the UE XnAP ID allocated by BS 710B (e.g., CU of BS 710B) in response to receiving the TMM response message. For example, when a TMM request message includes an invalid/ void UE XnAP ID (e.g., the non-F1-terminating BS UE XnAP ID IE in the TMM request message is invalid or void), BS 710C (e.g., CU of BS 710C) may store the UE XnAP ID in the non-F1-terminating BS UE XnAP ID IE in the corresponding TMM response message.

After the above operations, BS 710B (e.g., CU of BS 710B) and BS 710C (e.g., CU of BS 710C) may have the UE XnAP IDs allocated by each other for use over the Xn interface between BS 710B (e.g., CU of BS 710B) and BS 710C (e.g., CU of BS 710C).

After the TMM procedure, BS 710B (e.g., CU of BS 710B) may update the BAP configuration and the F1 traffic between network node 720 and BS 710C (e.g., CU of BS 710C) can be transported via the BH links under BS 710B (e.g., CU of BS 710B).

It should be appreciated by persons skilled in the art that the sequence of the operations in exemplary procedure 700 may be changed and some of the operations in exemplary procedure 700 may be eliminated or modified, without departing from the spirit and scope of the disclosure.

For example, FIG. 8 illustrates a flow chart of exemplary handover procedure 800 in accordance with some embodiments of the present disclosure.

Details described in all of the foregoing embodiments of the present disclosure are applicable for the embodiments shown in FIG. 8. For example, BSs 810A-810C may function as the IAB donors as described above and may include a CU and at least one DU. Network node 820 may function as the IAB nodes as described above, and may include an MT and a DU.

Network node 820 (e.g., DU of network node 820) may have an F1 connection with BS 810C (e.g., CU of BS 810C). Network node 820 (e.g., MT of network node 820) may have an RRC connection with BS 810A (e.g., CU of BS 810A). BS 810C and BS 810A may be referred to as an F1 terminating BS and a non-F1 terminating BS (or RRC terminating BS), respectively. The CU of BS 810C and the CU of BS 810A may be referred to as an F1 terminating BS-CU and a non-F1 terminating BS-CU (or RRC terminating BS-CU), respectively.

In some embodiments, the MT of network node 820 may perform a handover from BS 810A (i.e., source non-F1 terminating BS) to a target BS (i.e., target non-F1 terminating BS such as BS 810B) while the DU of network node 820 retains its connection with BS 810C (e.g., CU of BS 810C). For example, BS 810A, BS 810B, BS 810C and network node 820 may function as IAB donor 410A, IAB donor 410B, IAB donor 410C, and IAB node 420D in FIG. 4.

For example, referring to FIG. 8, in operation 811, a handover preparation procedure for network node 820 (e.g., MT of network node 820) may be performed between BS 810A and BS 810B. For example, BS 810A (e.g., CU of BS 810A) may transmit a handover request message to BS 810B (e.g., CU of BS 810B) to hand over network node 820 (e.g., MT of network node 820). BS 810B (e.g., CU of BS 810B) may transmit a response to the handover request message (e.g., positive feedback such as a handover request acknowledgement message or negative feedback such as a handover preparation failure message) to BS 810A.

In some embodiments, operation 811 may further include the following steps: BS 810B (e.g., CU of BS 810B) sets up the UE context for network node 820 (e.g., MT of network node 820) in the target parent node, performs admission control for network node 820 (e.g., MT of network node 820), and provides RRC reconfiguration (e.g., handover command) as a part of the handover request acknowledgement message.

In some embodiments, the handover request message may include a UE XnAP ID (e.g., an NG-RAN node UE XnAP ID, denoted as ID #8A) allocated by BS 810A (e.g., CU of BS 810A). The handover request acknowledgement message may include a UE XnAP ID (e.g., an NG-RAN node UE XnAP ID, denoted as ID #8B) allocated by BS 810B (e.g., CU of BS 810B). The handover request acknowledgement message may also include ID #8A. ID #8A and ID #8B can be used over the Xn interface between BS 810A (e.g., CU of BS 810A) and BS 810B (e.g., CU of BS 810B).

In operation 813, BS 810A (e.g., CU of BS 810A) may transmit a handover command (e.g., RRC reconfiguration) to network node 820 (e.g., MT of network node 820). In some embodiments, the handover command or RRC reconfiguration can be included in a UE context modification request message to the source parent node (e.g., DU of the source parent node of network node 820). In some examples, assuming that network node 820 functions as IAB node 420D in FIG. 4, the source and target parent nodes of network node 820 may be IAB node 420A and IAB node 420B, respectively. The source parent node (e.g., DU of the source parent node of network node 820) may forward the received handover command or RRC reconfiguration to the migrating node (e.g., MT of network node 820). In some examples, the source or target parent node of network node 820 may be a BS or an IAB donor.

In operation 815, network node 820 (e.g., MT of network node 820) may perform a random access procedure with the target parent node (e.g., DU of the target parent node of network node 820) and set up an RRC connection to BS 810B (e.g., CU of BS 810B).

In operation 817, BS 810A (e.g., CU of BS 810A) may request a UE XnAP ID (e.g., an NG-RAN node UE XnAP ID) for the MT of network node 820 from BS 810B (e.g., CU of BS 810B). As will be described later, the requested ID may be used over the Xn interface between BS 810B (e.g., CU of BS 810B) and BS 810C (e.g., CU of BS 810C).

For example, BS 810A (e.g., CU of BS 810A) may transmit a request message to BS 810B (e.g., CU of BS 810B) in operation 817. The request message may include an ID of BS 810C (e.g., CU of BS 810C) and an ID associated with network node 820. In some examples, the ID of BS 810C may include a gNB ID of BS 810C or a gNB-CU ID of the CU of BS 810C. In some examples, the descriptions regarding the ID associated with network node 720 may be applied to the ID associated with network node 820. For example, the ID associated with network node 820 may be the UE XnAP ID for the MT of network node 820 allocated by BS 810B (e.g., ID #8B) or BS 810A (e.g., ID #8A) and to be used over the Xn interface between BS 810A and BS 810B.

In some embodiments, the request message may include an indication to explicitly request for the UE XnAP ID. In some embodiments, such indication may be implicitly derived by the ID of BS 810C (e.g., CU of BS 810C). That is, when the request message includes the ID of BS 810C (e.g., CU of BS 810C), BS 810B (e.g., CU of BS 810B) may respond a UE XnAP ID (e.g., an NG-RAN node UE XnAP ID, denoted as ID #8B′) for the MT of network node 820 to be used over the Xn interface between BS 810B and BS 810C to BS 810A (e.g., CU of BS 810A). Put another way, in response to receiving the request message, BS 810B (e.g., CU of BS 810B) may allocate ID #8B′ and transmit a response message including ID #8B′ to BS 810A (e.g., CU of BS 810A).

In some embodiments, the request message may be (or included in) the handover request message (e.g., as described with respect to operation 811). The response message may be (or included in) the handover request acknowledgement message (e.g., as described with respect to operation 811). In some embodiments, the request message may be an XnAP message separate from the handover request message.

The response message may be an XnAP message separate from the handover request acknowledgement message. In some embodiments, operation 817 can be performed at any stage which is in parallel with or after the handover preparation procedure (e.g., operation 811) and before operation 819.

In operation 819, BS 810A (e.g., CU of BS 810A) may transmit a message to BS 810C (e.g., CU of BS 810C) to indicate that network node 820 (e.g., MT of network node 820) has been handed over to BS 810B (e.g., CU of BS 810B).

In some embodiments, the message in operation 819 may include an identifier of BS 810B (e.g., ID of CU of BS 810B), such that BS 810C (e.g., CU of BS 810C) can trigger a TMM procedure to the correct non-F1-terminating BS (e.g., non-F1-terminating CU such as CU of BS 810B). For example, the ID of BS 810B can be a gNB ID of BS 810B, gNB-CU ID of the CU of BS 810B, an IP address of the CU of BS 810B, or any ID that can identify BS 810B (e.g., CU of BS 810B).

In some embodiments, the message in operation 819 may include an ID associated with network node 820. As will be described later, the ID associated with network node 820 may be used for BS 810B (e.g., CU of BS 810B) to identify network node 820. The ID associated with network node 820 may be the UE XnAP ID (e.g., ID #8B′) allocated by BS 810B (e.g., CU of BS 810B) for the MT of network node 820 over the Xn interface between BS 810B and BS 810C.

BS 810C (e.g., CU of BS 810C) may then trigger a TMM procedure (e.g., IAB TMM procedure) to exchange information between BS 810C (e.g., CU of BS 810C) and BS 810B (e.g., CU of BS 810B) of network node 820 and to manage the migration of network node 820 and descendant node traffic between the topologies managed by the two BSs (e.g., the two CUs). For example, in operation 821, BS 810C (e.g., CU of BS 810C) may transmit a TMM request message to BS 810B (e.g., CU of BS 810B).

In some embodiments, the TMM request message may include the ID associated with network node 820 (e.g., ID #8B′) as described above with respect to operation 819. For example, in some embodiments, the TMM request message may include a non-F1-terminating BS UE XnAP ID IE (e.g., non-F1-terminating IAB-donor UE XnAP ID IE). The IE may include the ID associated with network node 820 (e.g., ID #8B′). For example, the value of the IE may be the ID associated with network node 820 (e.g., ID #8B′) or the IE may be set as the ID associated with network node 820 (e.g., ID #8B′).

In some embodiments, the TMM request message may include an F1-terminating BS UE XnAP ID IE (e.g., F1-terminating IAB-donor UE XnAP ID IE), which may include a UE XnAP ID (e.g., NG-RAN node UE XnAP ID) allocated by BS 810C (e.g., CU of BS 810C) and to be used over the Xn interface between BS 810B and BS 810C. For example, the value of the F1-terminating BS UE XnAP ID IE may be the UE XnAP ID allocated by BS 810C or the F1-terminating BS UE XnAP ID IE may be set as the UE XnAP ID allocated by BS 810C.

In some embodiments, in response to receiving the TMM request message, BS 810B (e.g., CU of BS 810B) can recognize network node 820 based on the non-F1-terminating BS UE XnAP ID IE in the TMM request message as it includes an ID (e.g., ID #8B′) allocated by itself.

After the above operations, BS 810B (e.g., CU of BS 810B) and BS 810C (e.g., CU of BS 810C) may have the UE XnAP IDs allocated by each other for use over the Xn interface between BS 810B (e.g., CU of BS 810B) and BS 810C (e.g., CU of BS 810C).

In operation 823, BS 810B (e.g., CU of BS 810B) may transmit a TMM response message to BS 810C (e.g., CU of BS 810C) as a response to the TMM request message.

In some embodiments, the TMM response message may include a non-F1-terminating BS UE XnAP ID IE (e.g., non-F1-terminating IAB-donor UE XnAP ID IE), which is set as the same value as the non-F1-terminating BS UE XnAP ID IE in the TMM request message. In some embodiments, the TMM response message may also include an F1-terminating BS UE XnAP ID IE (e.g., F1-terminating IAB-donor UE XnAP ID IE), which is set as the same value as the F1-terminating BS UE XnAP ID IE in the TMM request message.

After the TMM procedure, BS 810B (e.g., CU of BS 810B) may update the BAP configuration and the F1 traffic between network node 820 and BS 810C (e.g., CU of BS 810C) can be transported via the BH links under BS 810B (e.g., CU of BS 810B).

It should be appreciated by persons skilled in the art that the sequence of the operations in exemplary procedure 800 may be changed and some of the operations in exemplary procedure 800 may be eliminated or modified, without departing from the spirit and scope of the disclosure.

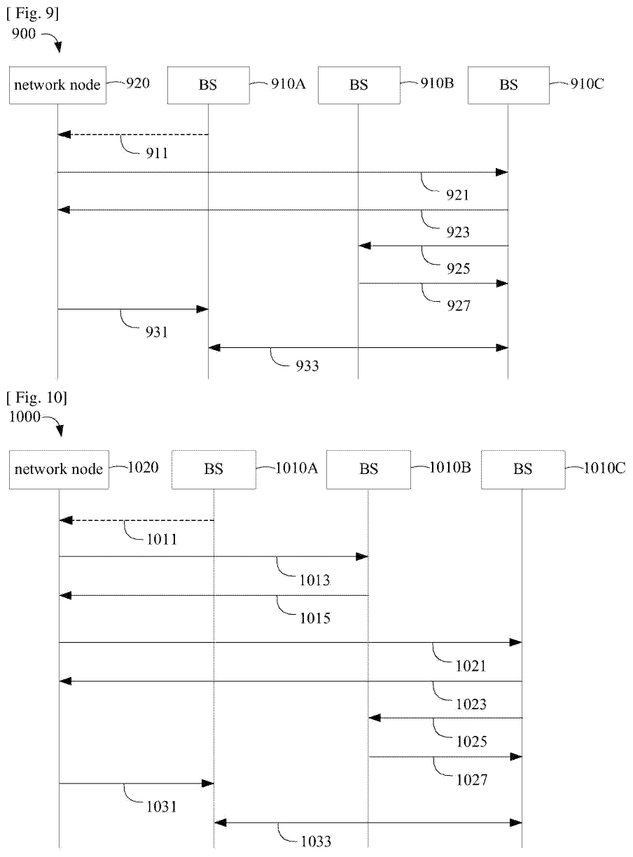

For example, FIG. 9 illustrates a flow chart of exemplary migration procedure 900 in accordance with some embodiments of the present disclosure.

Details described in all of the foregoing embodiments of the present disclosure are applicable for the embodiments shown in FIG. 9. For example, BSs 910A-910C may function as the IAB donors as described above and may include a CU and at least one DU. Network node 920 may function as the IAB nodes as described above, and may include an MT and at least one DU (e.g., one DU before and after DU migration or two DUs during the DU migration).

Network node 920 (e.g., DU of network node 920) may have an F1 connection with BS 910A (e.g., CU of BS 910A). Network node 920 (e.g., MT of network node 920) may have an RRC connection with BS 910B (e.g., CU of BS 910B). BS 910A and BS 910B may be referred to as an F1 terminating BS and a non-F1 terminating BS (or RRC terminating BS), respectively. The CU of BS 910A and the CU of BS 910B may be referred to as an F1 terminating BS-CU and a non-F1 terminating BS-CU (or RRC terminating BS-CU), respectively.

In some embodiments, the DU of network node 920 may perform a migration from BS 910A (i.e., source F1 terminating BS) to a target BS (i.e., target F1 terminating BS such as BS 910C) while the MT of network node 920 retains its connection with BS 910B. For example, BS 910A, BS 910B, BS 910C and network node 920 may function as IAB donor 510A, IAB donor 510B, IAB donor 510C, and IAB node 520D in FIG. 5.

In some embodiments, BS 910A (e.g., CU of BS 910A) may trigger the migration of the DU of network node 920. For example, in operation 911 (denoted by a dotted arrow as an option), BS 910A (e.g., CU of BS 910A) may transmit an F1AP message to indicate network node 920 to trigger a DU migration. For example, network node 920 may include a DU (denoted as DU #A1) having an F1 connection with BS 910A (e.g., CU of BS 910A). BS 910A (e.g., CU of BS 910A) may transmit the F1AP message to DU #A1.

In some embodiments, the F1AP message may include the ID of BS 910C (e.g., CU of BS 910C). The ID of BS 910C can be a gNB ID of BS 910C, gNB-CU ID of the CU of BS 910C, an IP address of the CU of BS 910C, or any ID that can identify BS 910C (e.g., CU of BS 910C).

In some other embodiments, the migration may be triggered by an operation administration and maintenance (OAM) entity or network node 920 itself (e.g., based on a pre-configuration on network node 920). In these embodiments, operation 911 can be omitted.

During the migration of the DU of network node 920, network node 920 may have an additional logical DU (denoted as DU #A2) besides DU #A1, wherein network node 920 (e.g., DU #A2) may need to set up an F1 connection to BS 910C (e.g., CU of BS 910C). In response to the initiating or triggering of the DU migration, network node 920 (e.g., DU #A2) may transmit an F1 setup request message to BS 910C (e.g., CU of BS 910C) in operation 921. For example, the F1 setup request message may be firstly transmitted to BS 910B (e.g., DU of BS 910B) and then delivered to BS 910C (e.g., CU of BS 910C) via IP routing.

In some embodiments, the F1 setup request message may include the ID of BS 910B (e.g., CU of BS 910B), such that BS 910C (e.g., CU of BS 910C) can trigger a TMM procedure to the correct non-F1-terminating BS (e.g., non-F1-terminating CU such as CU of BS 910B). The ID of BS 910B can be a gNB ID of BS 910B, gNB-CU ID of the CU of BS 910B, an IP address of the CU of BS 910B, or any ID that can identify BS 910B (e.g., CU of BS 910B).

In some embodiments, the F1 setup request message may include an ID associated with network node 920. As will be described later, the ID associated with network node 920 may be used for BS 910B (e.g., CU of BS 910B) to identify network node 920. That is, any ID associated with network node 920 that is known by BS 910B (e.g., CU of BS 910B) can be employed.

For example, the ID associated with network node 920 may be an ID of the MT of network node 920, an ID of the DU (e.g., DU #A1) of network node 920, or an ID of network node 920. For example, the ID associated with network node 920 may be a C-RNTI for the MT of network node 920, a BS-DU ID (e.g., gNB-DU ID) of the DU (e.g., DU #A1) of network node 920, a BAP address of network node 920, or a BS-DU UE F1AP ID (e.g., gNB-DU UE F1AP ID) of the DU (e.g., DU #A1) of network node 920. For example, the ID associated with network node 920 may be a UE XnAP ID allocated by BS 910A or BS 910B of the MT of the network node 920, which is to be used over the Xn interface between BS 910A and BS 910B. In this example, the network node 920 needs to obtain the UE XnAP ID from BS 910A or BS 910B in advance.

In response to receiving the F1 setup request message, BS 910C (e.g., CU of BS 910C) may transmit an F1 setup response message to network node 920 (e.g., DU #A2) in operation 923. The F1 setup response message may include a list of cells that BS 910C (e.g., CU of BS 910C) requests network node 920 (e.g., DU #A2) to activate. For example, the F1 setup response message may be firstly delivered to BS 910B (e.g., DU of BS 910B) via IP routing and then transmitted to network node 920 via BAP routing.

BS 910C (e.g., CU of BS 910C) may then trigger a TMM procedure (e.g., IAB TMM procedure) to exchange information between BS 910C (e.g., CU of BS 910C) and BS 910B (e.g., CU of BS 910B) of network node 920 and to manage the migration of network node 920 and descendant node traffic between the topologies managed by the two BSs (e.g., the two CUs). For example, in operation 925, BS 910C (e.g., CU of BS 910C) may transmit a TMM request message to BS 910B (e.g., CU of BS 910B).

In some embodiments, the TMM request message may include the ID associated with network node 920 as described above with respect to operation 921.

In some embodiments, the TMM request message may include a non-F1-terminating BS UE XnAP ID IE (e.g., non-F1-terminating IAB-donor UE XnAP ID IE). As described above with respect to FIG. 6, the F1-terminating BS (e.g., BS 910C) is supposed to include a UE XnAP ID (e.g., NG-RAN node UE XnAP ID) for the MT of a wireless network node (e.g., network node 920), which is allocated by the non-F1-terminating BS (e.g., BS 910B) and to be used over the Xn interface between the F1-terminating BS (e.g., BS 910C) and non-F1-terminating BS (e.g., BS 910B), in the non-F1-terminating BS UE XnAP ID IE. For example, the value of the IE is the ID or the IE is set as the ID. However, in the example of FIG. 9, BS 910C (e.g., CU of BS 910C) has no information for such UE XnAP ID at operation 925. BS 910C (e.g., CU of BS 910C) may set the non-F1-terminating BS UE XnAP ID IE in the TMM request message to be invalid or void.

In some embodiments, the ID associated with network node 920 may be included in an IE of the TMM request message which is different from the non-F1-terminating BS UE XnAP ID IE.

In some embodiments, the TMM request message may include an F1-terminating BS UE XnAP ID IE (e.g., F1-terminating IAB-donor UE XnAP ID IE), which may include a UE XnAP ID (e.g., NG-RAN node UE XnAP ID) allocated by BS 910C (e.g., CU of BS 910C) and to be used over the Xn interface between BS 910C and BS 910B. For example, the value of the F1-terminating BS UE XnAP ID IE may be the UE XnAP ID allocated by BS 910C or the F1-terminating BS UE XnAP ID IE may be set as the UE XnAP ID allocated by BS 910C.

In some embodiments, based on the ID associated with network node 920 in the TMM request message, BS 910B (e.g., CU of BS 910B) can recognize network node 920. In some embodiments, BS 910B (e.g., CU of BS 910B) may ignore the non-F1-terminating BS UE XnAP ID IE in the TMM request message. For example, when the TMM request message includes the ID associated with network node 920, BS 910B (e.g., CU of BS 910B) may ignore the non-F1-terminating BS UE XnAP ID IE.

In some embodiments, BS 910B (e.g., CU of BS 910B) may allocate a UE XnAP ID (e.g., NG-RAN node UE XnAP ID) for the MT of network node 920 to be used over the Xn interface between BS 910B and BS 910C in response to receiving the TMM request message. For example, when the TMM request message includes the ID associated with network node 920, BS 910B (e.g., CU of BS 910B) may allocate the UE XnAP ID for the MT of network node 920.

In operation 927, BS 910B (e.g., CU of BS 910B) may transmit a TMM response message to BS 910C (e.g., CU of BS 910C) as a response to the TMM request message. In some embodiments, the TMM response message may include the UE XnAP ID allocated by BS 910B (e.g., CU of BS 910B) to be used over the Xn interface between the F1-terminating BS (e.g., BS 910C) and non-F1-terminating BS (e.g., BS 910B). For example, BS 910B (e.g., CU of BS 910B) may set a non-F1-terminating BS UE XnAP ID IE (e.g., non-F1-terminating IAB-donor UE XnAP ID IE) in the TMM response message to be the allocated UE XnAP ID. For example, the value of the non-F1-terminating BS UE XnAP ID IE in the TMM response message is the allocated UE XnAP ID.

In some embodiments, the TMM response message may also include an F1-terminating BS UE XnAP ID IE (e.g., F1-terminating IAB-donor UE XnAP ID IE), which is set as the same value as the F1-terminating BS UE XnAP ID IE in the TMM request message.

In some embodiments, BS 910C (e.g., CU of BS 910C) may store the UE XnAP ID allocated by BS 910B (e.g., CU of BS 910B) in response to receiving the TMM response message. For example, when a TMM request message includes an invalid/ void UE XnAP ID (e.g., the non-F1-terminating BS UE XnAP ID IE in the TMM request message is invalid or void), BS 910C (e.g., CU of BS 910C) may store the UE XnAP ID in the non-F1-terminating BS UE XnAP ID IE in the corresponding TMM response message.

After the above operations, BS 910B (e.g., CU of BS 910B) and BS 910C (e.g., CU of BS 910C) may have the UE XnAP IDs allocated by each other for use over the Xn interface between BS 910B (e.g., CU of BS 910B) and BS 910C (e.g., CU of BS 910C).

After the TMM procedure, BS 910B (e.g., CU of BS 910B) may update the BAP configuration and the F1 traffic between network node 920 and BS 910C (e.g., CU of BS 910C) can be transported via the BH links under BS 910B (e.g., CU of BS 910B).

In some embodiments, after the F1 setup between DU #A2 and BS 910C (e.g., CU of BS 910C), network node 920 (e.g., DU #A1) may, in operation 931, indicate to BS 910A (e.g., CU of BS 910A) the completion of the F1 setup to BS 910C (e.g., CU of BS 910C) and inform BS 910A (e.g., CU of BS 910A) the list of cells that BS 910C (e.g., CU of BS 910C) requests network node 920 (e.g., DU #A2) to activate.

In some embodiments, in response to receiving the information in operation 931, BS 910A (e.g., CU of BS 910A) may, in operation 933, trigger a handover(s) of the UE (s) served by network node 920 (e.g., DU #A1) from BS 910A (e.g., CU of BS 910A) to BS 910C (e.g., CU of BS 910C).

It should be appreciated by persons skilled in the art that the sequence of the operations in exemplary procedure 900 may be changed and some of the operations in exemplary procedure 900 may be eliminated or modified, without departing from the spirit and scope of the disclosure. For example, operations 931 and 933 may be performed in parallel with or before operations 925 and 927.

For example, FIG. 10 illustrates a flow chart of exemplary migration procedure 1000 in accordance with some embodiments of the present disclosure.

Details described in all of the foregoing embodiments of the present disclosure are applicable for the embodiments shown in FIG. 10. For example, BSs 1010A-1010C may function as the IAB donors as described above and may include a CU and at least one DU. Network node 1020 may function as the IAB nodes as described above, and may include an MT and at least one DU (e.g., one DU before and after DU migration or two DUs during the DU migration).

Network node 1020 (e.g., DU of network node 1020) may have an F1 connection with BS 1010A (e.g., CU of BS 1010A). Network node 1020 (e.g., MT of network node 1020) may have an RRC connection with BS 1010B (e.g., CU of BS 1010B). BS 1010A and BS 1010B may be referred to as an F1 terminating BS and a non-F1 terminating BS (or RRC terminating BS), respectively. The CU of BS 1010A and the CU of BS 1010B may be referred to as an F1 terminating BS-CU and a non-F1 terminating BS-CU (or RRC terminating BS-CU), respectively.

In some embodiments, the DU of network node 1020 may perform a migration from BS 1010A (i.e., source F1 terminating BS) to a target BS (i.e., target F1 terminating BS such as BS 1010C) while the MT of network node 1020 retains its connection with BS 1010B. For example, BS 1010A, BS 1010B, BS 1010C and network node 1020 may function as IAB donor 510A, IAB donor 510B, IAB donor 510C, and IAB node 520D in FIG. 5.

In some embodiments, BS 1010A (e.g., CU of BS 1010A) may trigger the migration of the DU of network node 1020. For example, in operation 1011 (denoted by a dotted arrow as an option), BS 1010A (e.g., CU of BS 1010A) may transmit an F1AP message to indicate network node 1020 to trigger a DU migration. For example, network node 1020 may include a DU (denoted as DU #B1) having an F1 connection with BS 1010A (e.g., CU of BS 1010A). BS 1010A (e.g., CU of BS 1010A) may transmit the F1AP message to DU #B1.

In some embodiments, the F1AP message may include the ID of BS 1010C (e.g., CU of BS 1010C). The ID of BS 1010C can be a gNB ID of BS 1010C, gNB-CU ID of the CU of BS 1010C, an IP address of the CU of BS 1010C, or any ID that can identify BS 1010C (e.g., CU of BS 1010C).

In some other embodiments, the migration may be triggered by an OAM entity or network node 1020 itself (e.g., based on a pre-configuration on network node 1020). In these embodiments, operation 1011 can be omitted.

In some embodiments, before the migration of the DU of network node 1020, network node 1020 may obtain a UE XnAP ID (e.g., NG-RAN node UE XnAP ID, denoted as ID #10B′) for its MT, which is allocated by the non-F1-terminating BS (e.g., BS 1010B) of network node 1020 and to be used over the Xn interface between the target F1-terminating BS (e.g., BS 1010C) and non-F1-terminating BS (e.g., BS 1010B) of network node 1020.

For example, in operation 1013, network node 1020 may transmit a request message for a UE XnAP ID (e.g., ID #10B′) for the MT of network node 1020 to BS 1010B (e.g., CU of BS 1010B). As will be described later, the requested ID may be used over the Xn interface between BS 1010B (e.g., CU of BS 1010B) and BS 1010C (e.g., CU of BS 1010C).

In some embodiments, the request message may include an ID of BS 1010C (e.g., CU of BS 1010C). In some examples, the ID of BS 1010C may include a gNB ID of BS 1010C or a gNB-CU ID of the CU of BS 1010C.

In some embodiments, the request message may include an indication to explicitly request for the UE XnAP ID. In some embodiments, such indication may be implicitly derived by the ID of BS 1010C (e.g., CU of BS 1010C). That is, when the request message includes the ID of BS 1010C (e.g., CU of BS 1010C), BS 1010B (e.g., CU of BS 1010B) may respond a UE XnAP ID (e.g., ID #10B′) for the MT of network node 1020 to be used over the Xn interface between BS 1010B and BS 1010C to network node 1020. Put another way, in response to receiving the request message, BS 1010B (e.g., CU of BS 1010B) may allocate ID #10B′ and transmit a response message including ID #10B′ to network node 1020 in operation 1015.

In some embodiments, the request message and the response message may be transmitted via RRC signaling.

During the migration of the DU of network node 1020, network node 1020 may have an additional logical DU (denoted as DU #B2) besides DU #B1, wherein network node 1020 (e.g., DU #B2) may need to set up an F1 connection to BS 1010C (e.g., CU of BS 1010C). In operation 1021, network node 1020 (e.g., DU #B2) may transmit an F1 setup request message to BS 1010C (e.g., CU of BS 1010C). For example, the F1 setup request message may be firstly transmitted to BS 1010B (e.g., DU of BS 1010B) and then delivered to BS 1010C (e.g., CU of BS 1010C) via IP routing.

In some embodiments, the F1 setup request message may include the ID of BS 1010B (e.g., CU of BS 1010B), such that BS 1010C (e.g., CU of BS 1010C) can trigger a TMM procedure to the correct non-F1-terminating BS (e.g., non-F1-terminating CU such as CU of BS 1010B). The ID of BS 1010B can be a gNB ID of BS 1010B, gNB-CU ID of the CU of BS 1010B, an IP address of the CU of BS 1010B, or any ID that can identify BS 1010B (e.g., CU of BS 1010B).

In some embodiments, the F1 setup request message may include an ID associated with network node 1020. As will be described later, the ID associated with network node 1020 may be used for BS 1010B (e.g., CU of BS 1010B) to identify network node 1020. The ID associated with network node 1020 may be the UE XnAP ID (e.g., ID #10B′) allocated by BS 1010B (e.g., CU of BS 1010B) for the MT of network node 1020 over the Xn interface between BS 1010B and BS 1010C.

In response to receiving the F1 setup request message, BS 1010C (e.g., CU of BS 1010C) may transmit an F1 setup response message to network node 1020 (e.g., DU #B2) in operation 1023. The F1 setup response message may include a list of cells that BS 1010C (e.g., CU of BS 1010C) requests network node 1020 (e.g., DU #B2) to activate. For example, the F1 setup response message may be firstly delivered to BS 1010B (e.g., DU of BS 1010B) via IP routing and then transmitted to network node 1020 via BAP routing.

BS 1010C (e.g., CU of BS 1010C) may then trigger a TMM procedure (e.g., IAB TMM procedure) to exchange information between BS 1010C (e.g., CU of BS 1010C) and BS 1010B (e.g., CU of BS 1010B) of network node 1020 and to manage the migration of network node 1020 and descendant node traffic between the topologies managed by the two BSs (e.g., the two CUs). For example, in operation 1025, BS 1010C (e.g., CU of BS 1010C) may transmit a TMM request message to BS 1010B (e.g., CU of BS 1010B).

In some embodiments, the TMM request message may include the ID associated with network node 1020 (e.g., ID #10B′) as described above with respect to operation 1021. For example, in some embodiments, the TMM request message may include a non-F1-terminating BS UE XnAP ID IE (e.g., non-F1-terminating IAB-donor UE XnAP ID IE). The IE may include the ID associated with network node 1020 (e.g., ID #10B′). For example, the value of the IE may be the ID associated with network node 1020 (e.g., ID #10B′) or the IE may be set as the ID associated with network node 1020 (e.g., ID #10B′).

In some embodiments, the TMM request message may include an F1-terminating BS UE XnAP ID IE (e.g., F1-terminating IAB-donor UE XnAP ID IE), which may include a UE XnAP ID (e.g., NG-RAN node UE XnAP ID) allocated by BS 1010C (e.g., CU of BS 1010C) and to be used over the Xn interface between BS 1010C and BS 1010B. For example, the value of the F1-terminating BS UE XnAP ID IE may be the UE XnAP ID allocated by BS 1010C or the F1-terminating BS UE XnAP ID IE may be set as the UE XnAP ID allocated by BS 1010C.

In some embodiments, in response to receiving the TMM request message, BS 1010B (e.g., CU of BS 1010B) can recognize network node 1020 based on the non-F1-terminating BS UE XnAP ID IE in the TMM request message as it includes an ID (e.g., ID #10B′) allocated by itself.

After the above operations, BS 1010B (e.g., CU of BS 1010B) and BS 1010C (e.g., CU of BS 1010C) may have the UE XnAP IDs allocated by each other for use over the Xn interface between BS 1010B (e.g., CU of BS 1010B) and BS 1010C (e.g., CU of BS 1010C).

In operation 1027, BS 1010B (e.g., CU of BS 1010B) may transmit a TMM response message to BS 1010C (e.g., CU of BS 1010C) as a response to the TMM request message.

In some embodiments, the TMM response message may include a non-F1-terminating BS UE XnAP ID IE (e.g., non-F1-terminating IAB-donor UE XnAP ID IE), which is set as the same value as the non-F1-terminating BS UE XnAP ID IE in the TMM request message. In some embodiments, the TMM response message may also include an F1-terminating BS UE XnAP ID IE (e.g., F1-terminating IAB-donor UE XnAP ID IE), which is set as the same value as the F1-terminating BS UE XnAP ID IE in the TMM request message.

After the TMM procedure, BS 1010B (e.g., CU of BS 1010B) may update the BAP configuration and the F1 traffic between network node 1020 and BS 1010C (e.g., CU of BS 1010C) can be transported via the BH links under BS 1010B (e.g., CU of BS 1010B).

In some embodiments, after the F1 setup between DU #B2 and BS 1010C (e.g., CU of BS 1010C), network node 1020 (e.g., DU #B1) may, in operation 1031, indicate to BS 1010A (e.g., CU of BS 1010A) the completion of the F1 setup to BS 1010C (e.g., CU of BS 1010C) and inform BS 1010A (e.g., CU of BS 1010A) the list of cells that BS 1010C (e.g., CU of BS 1010C) requests network node 1020 (e.g., DU #B2) to activate.

In some embodiments, in response to receiving the information in operation 1031, BS 1010A (e.g., CU of BS 1010A) may, in operation 1033, trigger a handover(s) of the UE(s) served by network node 1020 (e.g., DU #B1) from BS 1010A (e.g., CU of BS 1010A) to BS 1010C (e.g., CU of BS 1010C).

It should be appreciated by persons skilled in the art that the sequence of the operations in exemplary procedure 1000 may be changed and some of the operations in exemplary procedure 1000 may be eliminated or modified, without departing from the spirit and scope of the disclosure. For example, operations 1031 and 1033 may be performed in parallel with or before operations 1025 and 1027.

FIG. 11 illustrates a flow chart of exemplary procedure 1100 for wireless communications in accordance with some embodiments of the present disclosure.

Details described in all of the foregoing embodiments of the present disclosure are applicable for the embodiments shown in FIG. 11. Exemplary procedure 1100 may be performed by a BS (e.g., an IAB donor).

Referring to FIG. 11, in operation 1111, a first BS may receive a TMM request message (e.g., an IAB TMM request message) from a second BS, wherein the TMM request message may include an identifier associated with a wireless network node for the first BS to identify the wireless network node.

In operation 1113, the first BS may transmit a TMM response message (e.g., an IAB TMM response message) to the second BS in response to receiving the TMM request message.

In some embodiments of the present disclosure, an MT of the wireless network node hands over from a third BS to the first BS and a DU of the wireless network node has an F1 connection to the second BS. In some embodiments of the present disclosure, the DU of the wireless network node migrates from a fourth BS to the second BS and the MT of the wireless network node has an RRC connection to the first BS.

In some embodiments of the present disclosure, the first BS may function as BS 710B in FIG. 7, BS 810B in FIG. 8, BS 910B in FIG. 9, or BS 1010B in FIG. 10. In some embodiments of the present disclosure, the second BS may function as BS 710C in FIG. 7, BS 810C in FIG. 8, BS 910C in FIG. 9, or BS 1010C in FIG. 10. In some embodiments of the present disclosure, the wireless network node may function as network node 720 in FIG. 7, network node 820 in FIG. 8, network node 920 in FIG. 9, or network node 1020 in FIG. 10. In some embodiments of the present disclosure, the third BS may function as BS 710A in FIG. 7 or BS 810A in FIG. 8. In some embodiments of the present disclosure, the fourth BS may function as BS 910A in FIG. 9 or BS 1010A in FIG. 10.

In some embodiments of the present disclosure, the identifier associated with the wireless network node may include one of the following: a C-RNTI for the MT of the wireless network node, a BS-DU ID (e.g., gNB-DU ID) of the DU of the wireless network node, a BAP address of the wireless network node, a UE XnAP ID (e.g., an NG-RAN node UE XnAP ID) for the MT of the wireless network node, and a BS-DU UE F1AP ID (e.g., gNB-DU UE F1AP ID) of the DU of the wireless network node.

In some embodiments of the present disclosure, the UE XnAP ID may be associated with the Xn interface between the first and third BSs. For example, the UE XnAP ID may be ID #7A or ID #7B as described above. In some embodiments of the present disclosure, the UE XnAP ID may be associated with the first and second BSs. For example, the UE XnAP ID may be ID #8B′ or ID #10B′ as described above.

In some embodiments of the present disclosure, during the migration of the DU of the wireless network node from the fourth BS to the second BS, the wireless network node may include a first DU having an F1 connection to the fourth BS and a second DU having an F1 connection to the second BS. The BS-DU ID of the DU of the wireless network node is a BS-DU ID of the first DU of the wireless network node and the BS-DU UE F1AP ID of the DU of the wireless network node is a BS-DU UE F1AP ID of the first DU of the wireless network node.

In some embodiments of the present disclosure, the TMM request message may include an IE indicating the identifier associated with the wireless network node and the IE is different from a non-F1-terminating BS UE XnAP ID IE in the TMM request message. In some embodiments of the present disclosure, the first BS may ignore the non-F1-terminating BS UE XnAP ID IE in the TMM request message.

In some embodiments of the present disclosure, the first BS may allocate a UE XnAP ID for the MT of the wireless network node to be used over an Xn interface between the first BS and the second BS in response to receiving the TMM request message. The TMM response message may include the allocated UE XnAP ID. For example, the TMM response message may include a non-F1-terminating BS UE XnAP ID IE, and the value of the IE may be set as the allocated UE XnAP ID.

In some embodiments of the present disclosure, the identifier associated with the wireless network node may include a UE XnAP ID for the MT of the wireless network node to be used over an Xn interface between the first BS and the second BS. In some embodiments of the present disclosure, the identifier associated with the wireless network node is included in a non-F1-terminating BS UE XnAP ID IE in the TMM request message. For example, the value of the IE is the identifier associated with the wireless network node or the UE XnAP ID. For example, the value of the IE is set as the identifier associated with the wireless network node or the UE XnAP ID for the MT of the wireless network node to be used over the Xn interface between the first BS and the second BS.

In some embodiments of the present disclosure, the first BS may allocate the UE XnAP ID for the MT of the wireless network node to be used over the Xn interface between the first BS and the second BS, and wherein the transceiver is further configured to transmit the allocated UE XnAP ID to the third BS or the wireless network node. In some embodiments of the present disclosure, the first BS may receive a request message for the UE XnAP ID from the third BS or the wireless network node, and wherein allocating the UE XnAP ID may include allocating the UE XnAP ID in response to receiving the request message. For example, the description with respect to operation 817 in FIG. 8 may apply here. For example, the description with respect to operations 1013 and 1015 in FIG. 10 may apply here.

For example, in some embodiments of the present disclosure, the request message is a handover request message from the third BS and the allocated UE XnAP ID is transmitted in a handover request acknowledgement message.

For example, in some embodiments of the present disclosure, the request message from the third BS may include an identifier of the second BS and the identifier associated with the wireless network node. For example, in some embodiments of the present disclosure, the request message from the wireless network node may include the identifier of the second BS.

It should be appreciated by persons skilled in the art that the sequence of the operations in exemplary procedure 1100 may be changed and some of the operations in exemplary procedure 1100 may be eliminated or modified, without departing from the spirit and scope of the disclosure.

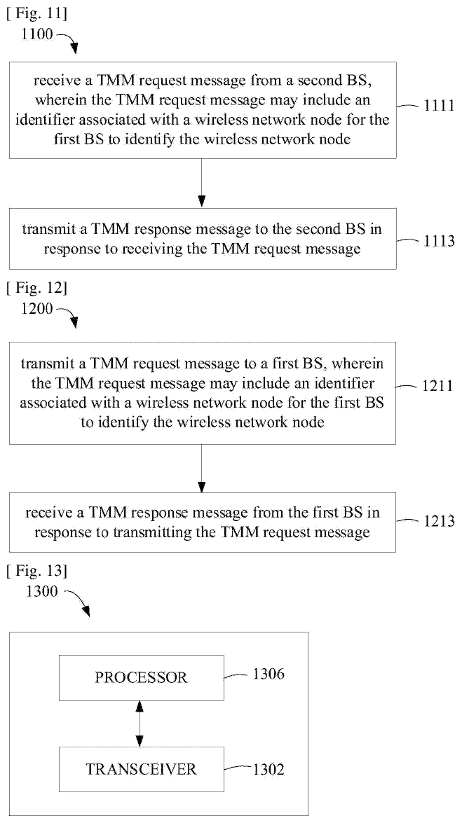

FIG. 12 illustrates a flow chart of exemplary procedure 1200 for wireless communications in accordance with some embodiments of the present disclosure.

Details described in all of the foregoing embodiments of the present disclosure are applicable for the embodiments shown in FIG. 12. Exemplary procedure 1200 may be performed by a BS (e.g., an IAB donor).

Referring to FIG. 12, in operation 1211, a second BS may transmit a TMM request message (e.g., an IAB TMM request message) to a first BS, wherein the TMM request message may include an identifier associated with a wireless network node for the first BS to identify the wireless network node.

In operation 1213, the second BS may receive a TMM response message (e.g., an IAB TMM response message) from the first BS in response to transmitting the TMM request message.

In some embodiments of the present disclosure, an MT of the wireless network node hands over from a third BS to the first BS and a DU of the wireless network node has an F1 connection to the second BS. In some embodiments of the present disclosure, the DU of the wireless network node migrates from a fourth BS to the second BS and the MT of the wireless network node has an RRC connection to the first BS.

In some embodiments of the present disclosure, the first BS may function as BS 710B in FIG. 7, BS 810B in FIG. 8, BS 910B in FIG. 9, or BS 1010B in FIG. 10. In some embodiments of the present disclosure, the second BS may function as BS 710C in FIG. 7, BS 810C in FIG. 8, BS 910C in FIG. 9, or BS 1010C in FIG. 10. In some embodiments of the present disclosure, the wireless network node may function as network node 720 in FIG. 7, network node 820 in FIG. 8, network node 920 in FIG. 9, or network node 1020 in FIG. 10. In some embodiments of the present disclosure, the third BS may function as BS 710A in FIG. 7 or BS 810A in FIG. 8. In some embodiments of the present disclosure, the fourth BS may function as BS 910A in FIG. 9 or BS 1010A in FIG. 10.

In some embodiments of the present disclosure, the second BS may receive the identifier associated with the wireless network node from the third BS. In some embodiments of the present disclosure, the identifier associated with the wireless network node may include one of the following: a C-RNTI for the MT of the wireless network node, a BS-DU ID (e.g., gNB-DU ID) of the DU of the wireless network node, a BAP address of the wireless network node, and a UE XnAP ID (e.g., an NG-RAN node UE XnAP ID) for the MT of the wireless network node.

In some embodiments of the present disclosure, the UE XnAP ID may be associated with the Xn interface between the first and third BSs. For example, the UE XnAP ID may be ID #7A or ID #7B as described above. In some embodiments of the present disclosure, the UE XnAP ID may be associated with the first and second BSs. For example, the UE XnAP ID may be ID #8B′ as described above.

In some embodiments of the present disclosure, the second BS may receive the identifier associated with the wireless network node from the wireless network node.

In some embodiments of the present disclosure, the identifier associated with the wireless network node may include one of the following: a C-RNTI for the MT of the wireless network node, a BS-DU ID (e.g., gNB-DU ID) of the DU of the wireless network node, a BAP address of the wireless network node, a UE XnAP ID (e.g., an NG-RAN node UE XnAP ID) for the MT of the wireless network node, and a BS-DU UE F1AP ID (e.g., gNB-DU UE F1AP ID) of the DU of the wireless network node. In some embodiments of the present disclosure, the UE XnAP ID may be associated with the first and second BSs. For example, the UE XnAP ID may be ID #10B′ as described above.

In some embodiments of the present disclosure, during the migration of the DU of the wireless network node from the fourth BS to the second BS, the wireless network node may include a first DU having an F1 connection to the fourth BS and a second DU having an F1 connection to the second BS. The BS-DU ID of the DU of the wireless network node is a BS-DU ID of the first DU of the wireless network node and the BS-DU UE F1AP ID of the DU of the wireless network node is a BS-DU UE F1AP ID of the first DU of the wireless network node.

In some embodiments of the present disclosure, the TMM request message may include an IE indicating the identifier associated with the wireless network node and the IE is different from a non-F1-terminating BS UE XnAP ID IE in the TMM request message. In some embodiments of the present disclosure, the second BS may set the non-F1-terminating BS UE XnAP ID IE in the TMM request message to be invalid or void.

In some embodiments of the present disclosure, the TMM response message may include a UE XnAP ID allocated by the first BS for the MT of the wireless network node to be used over an Xn interface between the first BS and the second BS. For example, the TMM response message may include a non-F1-terminating BS UE XnAP ID IE, and the value of the IE may be set as the UE XnAP ID allocated by the first BS. In some embodiments of the present disclosure, the second BS may store the UE XnAP ID allocated by the first BS.

In some embodiments of the present disclosure, the identifier associated with the wireless network node may include a UE XnAP ID allocated by the first BS for the MT of the wireless network node to be used over an Xn interface between the first BS and the second BS. In some embodiments of the present disclosure, the identifier associated with the wireless network node is included in a non-F1-terminating BS UE XnAP ID IE in the TMM request message. For example, the value of the IE is the identifier associated with the wireless network node or the UE XnAP ID allocated by the first BS. For example, the value of the IE is set as the identifier associated with the wireless network node or the UE XnAP ID allocated by the first BS.

In some embodiments of the present disclosure, the identifier associated with the wireless network node is received in an F1 setup request message.

It should be appreciated by persons skilled in the art that the sequence of the operations in exemplary procedure 1200 may be changed and some of the operations in exemplary procedure 1200 may be eliminated or modified, without departing from the spirit and scope of the disclosure.

FIG. 13 illustrates a block diagram of exemplary apparatus 1300 according to some embodiments of the present disclosure.

As shown in FIG. 13, the apparatus 1300 may include at least one processor 1306 and at least one transceiver 1302 coupled to the processor 1306. The apparatus 1300 may be a (wireless) network node (e.g., an IAB node), a BS (e.g., an IAB donor, IAB donor-CU, or IAB donor-DU), a DU of a BS, or a CU of a BS. In the case that apparatus 1300 is a BS, apparatus 1300 may further include a CU and at least one DU coupled to the CU. The CU and DU may be co-located or located separately. The CU and DU may be coupled to the processor 1306. In the case that apparatus 1300 is a (wireless) network node (stationary or mobile), apparatus 1300 may further include an MT and a DU coupled to the MT. The MT and DU may be coupled to the processor 1306.

Although in this figure elements such as the at least one transceiver 1302 and processor 1306 are described in the singular, the plural is contemplated unless a limitation to the singular is explicitly stated. In some embodiments of the present application, the transceiver 1302 may be divided into two devices, such as a receiving circuitry and a transmitting circuitry. In some embodiments of the present application, the apparatus 1300 may further include an input device, a memory, and/or other components.

In some embodiments of the present application, the apparatus 1300 may be a BS.

The processor 1306 may interact with other element(s) (e.g., transceiver 1302, a DU, or a CU) of the apparatus 1300 so as to perform the operations with respect to the BSs, the IAB donors, IAB donor-CUs, or IAB donor-DUs described in FIGS. 1-12. In some embodiments of the present application, the apparatus 1300 may be a (wireless) network node. The transceiver 1302 and the processor 1306 may interact with each other so as to perform the operations with respect to the network nodes or the IAB nodes (mobile or stationary) described in FIGS. 1-12.

In some embodiments of the present application, the apparatus 1300 may further include at least one non-transitory computer-readable medium.

In some embodiments of the present disclosure, the non-transitory computer-readable medium may have stored thereon computer-executable instructions to cause the processor 1306 to implement the method with respect to the BSs, the IAB donors, IAB donor-CUs, or IAB donor-DUs as described above. For example, the computer-executable instructions, when executed, cause the processor 1306 interacting with, for example, transceiver 1302 to perform the operations with respect to the BSs, the IAB donors, IAB donor-CUs, or IAB donor-DUs described in FIGS. 1-12.

For example, in some embodiments of the present disclosure, the non-transitory computer-readable medium may have stored thereon computer-executable instructions to cause the processor 1306 to implement the method with respect to the network nodes or the IAB nodes (mobile or stationary) as described above. For example, the computer-executable instructions, when executed, cause the processor 1306 interacting with transceiver 1302 to perform the operations with respect to the network nodes or the IAB nodes (mobile or stationary) described in FIGS. 1-12.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments.

For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover,” “path switch,” and “migration” may be used interchangeably. The terms “includes,” “including,” or any other variations thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first base station (BS) for wireless communication, comprising:
at least one memory; and
at least one processor, coupled with the at least one memory and configured to cause the first BS to:
receive a transport migration management (TMM) request message, wherein the TMM request message comprises an identifier associated with a wireless network node for the first BS to identify the wireless network node; and
transmit a TMM response message in response to receiving the TMM request message, wherein the first BS has a radio resource control (RRC) connection to a mobile termination (MT) of the wireless network node.

2. The first BS of claim 1, wherein the identifier associated with the wireless network node comprises a backhaul adaptation protocol (BAP) address of the wireless network node.

3. The first BS of claim 2, wherein the TMM request message comprises an information element (IE) indicating the BAP address of the wireless network node; and
wherein the at least one processor is further configured to cause the first BS to ignore a non-F1-terminating BS user equipment (UE) Xn application protocol (XnAP) identifier (ID) IE in the TMM request message.

4. The first BS of claim 1, wherein the identifier associated with the wireless network node comprises a UE XnAP ID for the MT of the wireless network node for use over an Xn interface between the first BS and a second BS.

5. The first BS of claim 4, wherein the at least one processor is further configured to cause the first BS to allocate the UE XnAP ID for the MT of the wireless network node for use over the Xn interface between the first BS and the second BS, and transmit the allocated UE XnAP ID to a third BS or the wireless network node.

6. The first BS of claim 5, wherein the at least one processor is further configured to cause the first BS to receive a request message for the UE XnAP ID from the third BS or the wireless network node, and wherein to allocate the UE XnAP ID the at least one processor is further configured to cause the UE to allocate the UE XnAP ID in response to receiving the request message.

7. The first BS of claim 6, wherein a request message from the third BS comprises an identifier of the second BS and the identifier associated with the wireless network node; or wherein the request message from the wireless network node comprises the identifier of the second BS.

8. A second base station (BS), comprising:
at least one memory; and
at least one processor, coupled with the at least one memory and configured to cause the second BS to:
transmit a transport migration management (TMM) request message, wherein the TMM request message comprises an identifier associated with a wireless network node for a first BS to identify the wireless network node; and
receive a TMM response message in response to transmitting the TMM request message, wherein a distributed unit (DU) of the wireless network node has an F1 connection to the second BS, or wherein the DU of the wireless network node migrates from a fourth BS to the second BS.

9. The second BS of claim 8, wherein the identifier associated with the wireless network node comprises a backhaul adaptation protocol (BAP) address of the wireless network node.

10. The second BS of claim 8, wherein the at least one processor is further configured to cause the second BS to receive the identifier associated with the wireless network node from the wireless network node, and wherein the identifier associated with the wireless network node comprises one of: a cell radio network temporary identifier (C-RNTI) for a mobile termination (MT) of the wireless network node, a BS-DU identifier (ID) of the DU of the wireless network node, a backhaul adaptation protocol (BAP) address of the wireless network node, a user equipment (UE) Xn application protocol (XnAP) ID for the MT of the wireless network node, or a BS-DU UE F1 application protocol (F1AP) ID of the DU of the wireless network node.

11. The second BS of claim 8, wherein the TMM request message comprises an information element (IE) indicating the identifier associated with the wireless network node and the IE is different from a non-F1-terminating BS UE Xn application protocol (XnAP) identifier (ID) IE in the TMM request message.

12. The second BS of claim 11, wherein the at least one processor is further configured to cause the second BS to set the non-F1-terminating BS UE XnAP ID IE in the TMM request message to be invalid or void.

13. The second BS of claim 11, wherein the TMM response message comprises a UE XnAP ID allocated by the first BS for a mobile termination (MT) of the wireless network node for use over an Xn interface between the first BS and the second BS.

14. The second BS of any of claim 8, wherein the identifier associated with the wireless network node comprises a user equipment (UE) Xn application protocol (XnAP) identifier (ID) allocated by the first BS for a mobile termination (MT) of the wireless network node for use over an Xn interface between the first BS and the second BS.

15. A method performed by a first base station (BS), the method comprising:
receiving a transport migration management (TMM) request message, wherein the TMM request message comprises an identifier associated with a wireless network node for the first BS to identify the wireless network node; and
transmitting a TMM response message in response to receiving the TMM request message, wherein the first BS has a radio resource control (RRC) connection to a mobile termination (MT) of the wireless network node.

16. The method of claim 15, wherein the identifier associated with the wireless network node comprises a backhaul adaptation protocol (BAP) address of the wireless network node.

17. The method of claim 16, wherein the TMM request message comprises an information element (IE) indicating the BAP address of the wireless network node; and
further comprising ignoring a non-F1-terminating BS user equipment (UE) Xn application protocol (XnAP) identifier (ID) IE in the TMM request message.

18. The method of claim 15, wherein the identifier associated with the wireless network node comprises a user equipment (UE) Xn application protocol (XnAP) identifier (ID) for a mobile termination (MT) of the wireless network node for use over an Xn interface between the first BS and a second BS.

19. The method of claim 18, further comprising:
allocating the UE XnAP ID for the MT of the wireless network node for use over the Xn interface between the first BS and the second BS; and
transmitting the allocated UE XnAP ID to a third BS or the wireless network node.

20. A method performed by a second base station (BS), the method comprising:
transmitting a transport migration management (TMM) request message, wherein the TMM request message comprises an identifier associated with a wireless network node for a first BS to identify the wireless network node; and
receiving a TMM response message in response to transmitting the TMM request message, wherein a distributed unit (DU) of the wireless network node has an F1 connection to the second BS, or wherein the DU of the wireless network node migrates from a fourth BS to the second BS.
